(19) United States
(12) Patent Application Publication
(10) Pub. No.: US 2023/0359993 A1
(43) Pub. Date: Nov. 9, 2023

(54) Methods and Systems for Middle-Channel Consolidation of Distributed Objects

(71) Applicant: Deliverider LTD, Nes Ziona (IL)

(72) Inventors: Ido Raz, Nes Ziona (IL); Elad Kantor, Hod HaSharon (IL)

(73) Assignee: Deliverided LTD, Nes Ziona (IL)

(21) Appl. No.: 18/140,586

(22) Filed: Apr. 27, 2023

Related U.S. Application Data
(60) Provisional application No. 63/338,770, filed on May 5, 2022.

(51) Int. Cl. G06Q 10/0875

(52) U.S. Cl. CPC G06Q 10/0875

(57) ABSTRACT

Systems and method are provided for a middle-channel consolidation system. A computing device may receive an object request that identifies a set of objects to be received at a second location. The computing device identifies one or more independent environments from which the objects may be transmitted to the second location. The computing device may identify one or more dynamic routes using a topology algorithm that defines paths between the independent environments and the second location. The computing device may then generate a specification for each dynamic route and transmit the specifications to delivery devices configured to facilitate the transmission of the set of objects from the one or more independent environments to the second location. When the set of objects are received at the second location, the set of objects may be consolidated with other objects provided by a distribution device to form a package.

### CROSS-REFERENCE TO RELATED APPLICATIONS

The present patent application claims the benefit of priority to U.S. Provisional Patent Application No. 63/338,770 filed May 5, 2022, which is incorporated herein by reference in its entirety for all purposes.

### TECHNICAL FIELD

This disclosure generally relates to middle-channel consolidation of third-party objects for distribution; and more specifically to consolidating third-party objects with primary objects for last-channel distribution.

### BACKGROUND

Object requests can include transmission paths involving a number of intermediate devices. An independent environment may transmit objects requested by a first object request to a nearby network or distribution center with objects of other object requests. As a result, the independent environment may consolidate objects of multiple object requests for fewer transmissions via a larger package size. Last-channel distribution of objects can refer to the final step in object transmission from a distribution center to an end user. Often, last-channel distribution can add significant complexity to fulfilling object requests. For example, last-channel distribution may include distributing a relatively small quantity of objects to each of a large quantity of end users, which may induce a large resource cost for the last-channel portion of the object request. While some alternative object distribution methods have been provided (e.g., transmitting objects directly from an independent environment to the end user skipping one or more intermediate devices, consolidation with other independent environments, etc.), these methods merely shift the resource burden to other intermediary devices, are impractical for sources that distribute objects through alternative channels, and are impractical for certain types of independent environments (e.g., such as those that distribute smaller quantities of objects).

### SUMMARY

Methods and systems are described herein for mid-channel consolidation of distributed objects. The methods include: receiving, from a distribution device, an object request that includes an identification of a first one or more objects to be distributed in a package with a second one or more objects; identifying, from the identification of the first one or more objects, one or more source locations of independent environments associated with each of the one or more objects; identifying, based on a topology algorithm, one or more dynamic routes that includes an identification of a path over which the first one or more objects will travel from the one or more source locations to a second location; selecting a set of dynamic routes from the one or more dynamic routes; generating a specification for each dynamic route of the set of dynamic routes, each specification including an identification of a device of a set of devices configured to facilitate the transmission of objects to the second location and an identification of the dynamic route from the set of dynamic routes; and transmitting each specification to the device of the set of devices, wherein upon execution of each specification, the first one or more objects are transmitted to the second location causing the first one or more objects to be consolidated with the second one or more objects forming a package.

Systems are described herein for mid-channel consolidation of distributed objects. The systems include one or more processors and a non-transitory computer-readable medium storing instructions that, when executed by the one or more processors, cause the one or more processors to perform any of the methods as previously described.

Non-transitory computer-readable media are described herein for storing instructions that, when executed by the one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

FIG. 1 illustrates an example logistical map depicting locations of distribution centers and independent environments of a hyperlocal network according to aspects of the present disclosure.

FIG. 2 illustrates exemplary transmission routes from independent environments to distribution centers, and from distribution centers to end users according to aspects of the present disclosure.

FIG. 3 illustrates a block diagram of an example system configured to define hyperlocal networks by allocating independent environments with distribution centers according to aspects of the present disclosure.

FIG. 4 illustrates a block diagram of an example system configured to identify particular independent environments that satisfy object requests received from distribution centers according to aspects of the present disclosure.

FIG. 5 illustrates a block diagram of an example system configured to define dynamic routes between independent environments and distribution centers according to aspects of the present disclosure.

FIG. 6 illustrates a flowchart of an example method of consolidating third-party objects with primary objects of an object request at distribution centers for distribution according to aspects of the present disclosure.

FIG. 7 illustrates a flowchart of an example method of generating hyperlocal networks based on independent environments allocated to distribution centers according to aspects of the present disclosure.

FIG. 8 illustrates a flowchart of an example method of defining aggregated object manifests according to aspects of the present disclosure.

FIG. 9 illustrates a flowchart of an example method of integrating manifests generated from independent environments into a primary object distribution platform of an object distributor according to aspects of the present disclosure.

FIG. 10 illustrates a flowchart of an example method of transmitting specifications to transmission-based devices configured to facilitate the transmission of objects from independent environments to distribution centers according to aspects of the present disclosure.

FIG. 11 illustrates a flowchart of another example process of consolidating objects of one or more independent environments with primary objects of a distribution center according to aspects of the present disclosure.

FIG. 12 illustrates an example computing device architecture of a computing device that can implement the various techniques described herein according to aspects of the present disclosure

### DETAILED DESCRIPTION

The present disclosure includes systems and methods for middle-channel consolidation of distributed objects for distribution. A distribution environment may operate within one or more object distribution channels to provide objects to end users. The distribution environment may provide some objects through a physical location and prepare other objects for transmission to remote device through a distribution center. Some objects provided by the distribution environment may be primary objects (e.g., objects provided by the distribution environment). The distribution environment may also provide third-party objects (e.g., objects provided by independently operated environments). For example, the distribution environment may provide an interface through which end users may generate object requests including primary objects and/or third-party objects. The distribution environment may transmit the object request to a computing device of a middle-channel consolidation system, which may facilitate the transmission of the third-party objects to the distribution channel where the third-party objects may be consolidated with the primary objects to form a package. The distribution center may then facilitate distribution of the package to the end user.

The middle-channel consolidation system may provide reduce resources consumed in the transmission of objects requested by the end user by enable the distribution environment to facilitate the transmission of both primary objects and third-party objects from a distribution center. Without the middle-channel consolidation system, the end user may request objects from multiple sources (e.g., one or more independent environments, one or more distribution environments, etc.) causes the objects to be packaged in multiple packages and distributed individually to the end user. The middle-channel consolidation system enables the distribution environment to provide the objects of multiple independent environments through a central platform. The middle-channel consolidation system may then facilitate the transmission of those objects for consolidation at the distribution center of the distribution environment such that a single package may be distributed to the end user with each object requested.

The middle-channel consolidation system may establish hyperlocal networks based on a location of a distribution center. Independent environments that register with the middle-channel consolidation system may be allocated to one or more distribution centers based on one or more factors (e.g., proximity, optimal transmission paths, average transmission times, etc.). Once allocated, the middle-channel consolidation system may define a hyperlocal network map that includes the distribution center, each independent environment allocated to the distribution center, and/or other map features (e.g., topography, routes between independent environments and/or distribution centers, etc.).

Independent environments may transmit an object manifest to the middle-channel consolidation system that includes an identification of a set of objects of the independent environment that may be provided by the distribution center, characteristics each object of the set of objects (e.g., mass, size, etc.), a quantity of each object of the set of objects, metadata associated with each object of the set of objects (e.g., age, instructions, warnings etc.), restrictions (e.g., temperature, time intervals over which the object is viable, etc.). The manifest may also include a representation of the objects stored and/or provided by the independent environment. The representation may include an image, three-dimensional model, video, audio, and/or the like. The middle-channel consolidation system may process the manifest and aggregate the manifest with other manifests from other independent environments within the hyperlocal network to form an aggregated manifest for the hyperlocal network. The aggregated manifest may be transmitted to the distribution environment and/or a computing device of the distribution center. The distribution environment may generate an interface enabling end users to select objects stored and/or provided by the distribution environment (e.g., via the distribution center of the distribution environment) and objects stored and provided by the independent environment of the hyperlocal network based on the aggregated manifest.

The computing device may maintain an up-to-date aggregated manifest for each hyperlocal network that incorporates the manifests of each independent environment allocated to the hyper local network. When independent environment detects a change in the internal manifest of the independent environment, the independent environment may transmit an updated manifest to the computing device. In some instances, independent environments may periodically (e.g., in regular intervals, upon request, detection of an event such as an object order, etc.) transmit updated object manifests to the computing device. In other instances, the independent environment may transmit an updated manifest each time objects stored and/or provided by the independent environment have changed. An updated manifest may include a full manifest of the objects stored and/or provided by the independent environment (e.g., as the previously described manifest). Alternatively, the updated manifest may be a delta data structure that includes an identification of only those objects that have changed such as, but not limited to, an identification of new objects, an identification of objects that are no longer available, a revised quantity of objects (e.g., based on an object request having been satisfied, new objects having been received, etc.), and/or the like. Delta data structures may be much smaller than the manifest, which may be reduce the resources needed to store, transmit, and process updates to the manifest by both the independent environment and the computing device. The updated manifest may also include a representation of any new objects stored and/or provided by the independent environment. The representation may include an image, three-dimensional model, video, audio, and/or the like.

When the distribution environment transmits an object request including objects stored and/or provided by independent environments to the computing device of middle-channel consolidation system, the computing device may facilitate the transmission of the objects to the distribution center for consolidation with object (if any) of distribution environment. The computing device may identify a set of devices (e.g., drones such as autonomous drones or user driven drones, mobile devices operated by a delivery person, a four-wheeled vehicle, a two-wheeled vehicle, etc.) available during the time interval within which the objects are to be distributed and configured to transmit the objects from one or more independent environments to the distribution center. The computing device may then use a topology algorithm to define dynamic routes for one or more of the set of devices. In some instances, the topology algorithm may include constraints such as, shortest distance, smallest quantity of traffic given a time of day, weather, quantity of independent environments from which objects are being transmitted, location of independent environments, etc. The computing device may then generate a specification that includes a dynamic route for a particular device of the set of devices, an identification of objects to be transmitted by the particular device, a time interval over which the objects are to be transmitted (e.g., such as a time window, a timestamp when the objects are to initiate transmission, a timestamp when the objects are to be received by the distribution center, and/or the like), and/or the like. The specifications may be transmitted to each device of the one or more devices for execution.

The computing device may transmit a communication to each independent environment with an identification of the object request and an indication as to when the objects are to be prepared (e.g., set aside, labeled, and/or the like) for transmission. The computing device may also transmit communications to a device associated with the distribution environment and/or distribution center with a status of the object request. The communication may be transmitted periodically (e.g., in regular intervals), when a status changes (e.g., when objects have been begun transmission, when objects have been received by the distribution center, when a delay has occurred due to weather or traffic, etc.). In some instances, the computing device may store the status of the object request and expose an application programming interface (API) to the device of the distribution environment and/or distribution center. The device of the distribution environment and/or distribution center may use the exposed API to access the status information. The computing device may transmit notifications to the device of the distribution environment and/or distribution center when the object request status has changed.

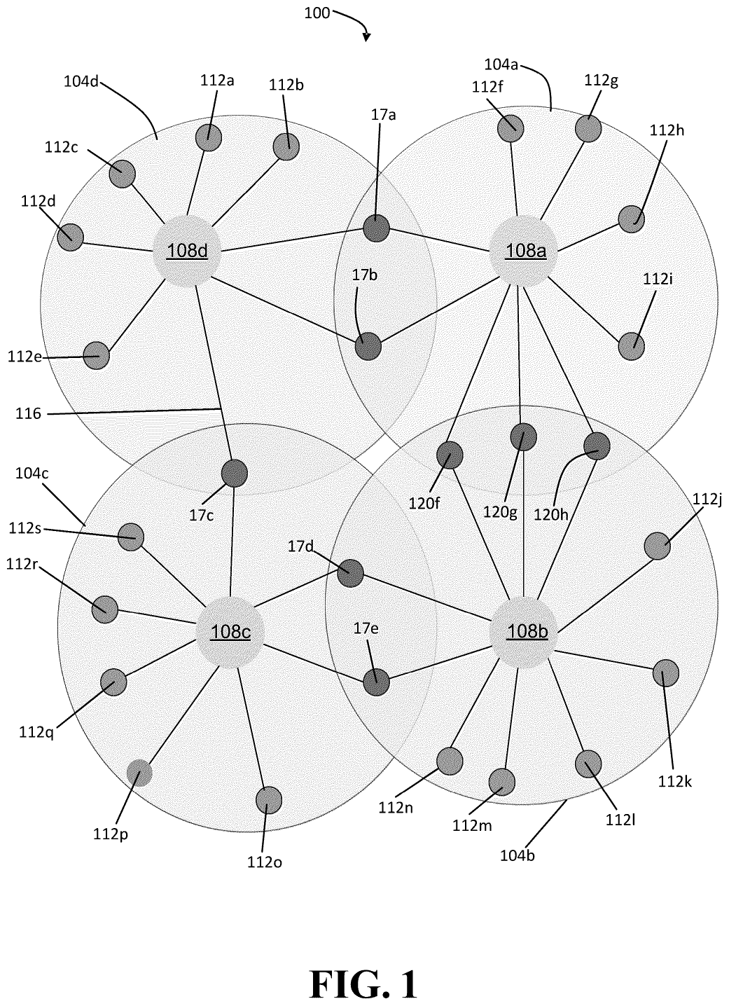

FIG. 1 illustrates an example logistical map depicting locations of distribution centers and independent environments of a hyperlocal network according to aspects of the present disclosure. Logistical map 100 includes four example hyperlocal networks, 104a, 104b, 104c, and 104d. Hyperlocal networks 104a and 104b may be defined around distribution centers of a particular distribution environment (e.g., “distributor A”). Distributor A may operate distribution centers 108a and 108b through which object stored and/or provided by distributor A may be provided and/or transmitted to end users. Hyperlocal networks 104c and 104d may be defined around distribution centers of another particular distribution environment (e.g., “distributor B”, which may operate distribution centers 108c and 108d. Each hyperlocal network 104 may further include one or more independent environment 112a-112s. Connection 116 may represent interconnections between individual independent environments 112 and a distribution center 108. The interconnections may be facilitated by middle-channel consolidation service that may transmit objects (e.g., items, products, etc.) stored and/or provided by independent environments 112 to proximate distribution centers of distributor A or distributor B (and/or additional distribution environment not shown).

Some independent environments 112, may be connected to a single distribution center 108 (e.g., such as independent environments 17a-17e and 112a-112s, etc.) indicating that objects from those environments 112 may be transmitted to a single distribution center 108. Other independent environments 120a-120h may be connected to (and provide objects to) multiple distribution centers. For example, independent environment 120f may provide objects to distribution center 108a and distribution 108b. In some instances, independent environments 120 may be limited to distribution centers operated by a same distribution environment. In other instances, independent environments 120 may be connected to distribution centers operated by any number of distribution centers operated by any distribution environment. One or more factors may be used to determine a quantity of distribution centers (and which distribution centers) that an independent environment may be allocated. Examples of such factors may include, but are not limited to, proximity to a distribution center, objects provided by the independent environment, whether other independent environments store and/or provide similar or the same objects (e.g., such that the other independent environment may provide those objects to a distribution environment), routes between the independent environment and the distribution center, frequency with which the independent environment distributes objects to a distribution center, and/or the like.

Map 100 may include a representation of other features associated with hyperlocal networks 104 such as a range over which a distribution center 108 distributes objects (e.g., via a last-channel delivery service, etc.), topological features (e.g., routes between independent environments and distribution centers, routes between distribution centers, etc.) and/or the like. A middle-channel consolidation system may generate map 100 for each distribution environment, for one or more distribution environment that share connections to at least one independent environment 120, and/or the like. In some instances, the map 100 may be represented as a data structured that may be usable to identify independent environments, identify distribution centers, allocate independent environments to distribution center, dynamically define routes between independent environments 112/120 and distribution centers 108, and/or the like. For instance, the middle-channel consolidation system may execute a machine-learning model using map 100 and/or a portion of map 100 for defining a route between one or more independent environments 112 and a distribution center 108. In other instances, map 100 may be represented graphically (e.g., via a graphical user interface, or the like). The middle-channel consolidation system may expose one or more APIs configured to provide access to the map 100. For example, a device of a distribution center may execute functions of the one or more APIs to access information associated with map (e.g., such as an identification of the particular independent environments allocated to that distribution center, etc.).

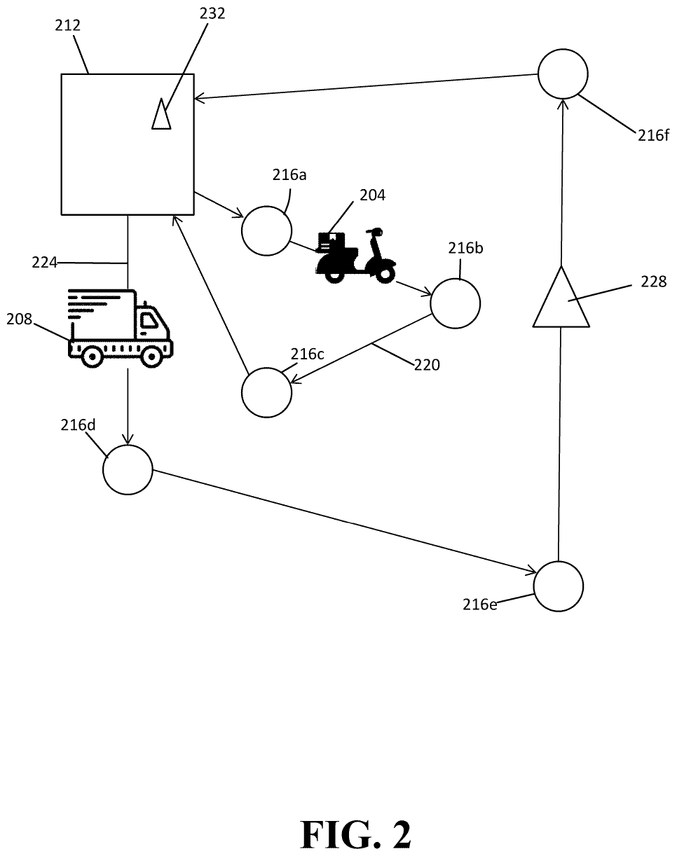

FIG. 2 illustrates exemplary transmission routes from independent environments to distribution centers, and from distribution centers to end users according to aspects of the present disclosure. The middle-channel consolidation system may provide middle-channel transmission services. Independent environments may prepare a package (e.g., of objects) for transmission by a middle-channel delivery device (e.g., a gasoline or electrical vehicle such as, but not limited to a drone, two-wheeled vehicle 204, four-wheeled vehicle 208, etc.). The delivery device may receive the objects from the independent environment and transmit the objects to a distribution device, which may operate a last-channel delivery service. The objects may be consolidated with other objects of other independent environments and/or object from the distribution center and provided to the end user (e.g., via pick up or the last-channel delivery services operated or provided by the distribution center).

A first deliver device 204 may be selected based on a particular route, based on objects being transmitted (e.g., size, mass, etc.), proximity of one or more independent environments from the distribution center, an average time to transmit objects, etc. For example, deliver device 204 may be a two-wheeled device or drone (e.g., user operated or autonomous) that operates within a predetermined proximity from the distribution center. Deliver device 204 may be selected based on an average time interval to complete route 220 (e.g., distribution center 112 to independent environment 216a, independent environment 216b, independent environment 216c, and back to distribution center 212).

Delivery device 208 may be selected for longer routes based on characteristics of delivery device 208 (e.g., having a larger mass allowance, can travel farther distances, time interval over which delivery device 208 can complete a particular route, etc.). For example, delivery device 208 may be selected for route 224, which may include distribution center 212, independent environment 216d, independent environment 216e, self-managed storage environment 228 (e.g., an interim or permanent object consolidation location operated by the middle-channel consolidation system), independent environment 216f, and back to distribution center 212.

Delivery devices 204/208 may execute a particular route in regular intervals (e.g., one or more times per day, etc.), just-in-time (JIT) (e.g., in response to an object request being received from distribution center 212). The delivery devices may transport from independent environments 216 to distribution center 212. Once the objects are received by distribution center 212, the objects may be consolidated with other objects provided by the distribution center (e.g., primary objects) that were requested by a same end user. In some examples, the objects may be positioned within a predetermined storage sublocation 232 of distribution center 212. The primary objects and the objects from independent environments may be consolidated to form a single package for distribution. A last-channel delivery service may transmit the package to the end user. Alternatively, the end user may retrieve the package directly from the distribution center 212, self-managed storage environment 228, etc. In some instances, the end user may retrieve some or all of the objects requested at an independent environment 216. For example, the middle-channel consolidation system may store objects received from independent environments along route 224 at self-managed storage environment 228 or a particular independent environment 216. In some instances, the middle middle-channel consolidation system may also retrieve primary objects from distribution center 212. In those instances, the middle-channel consolidation system may consolidate the primary objects and objects from independent environments 216 at the pick-up location (e.g., a particular independent environment 216, self-managed storage environment 228, etc.).

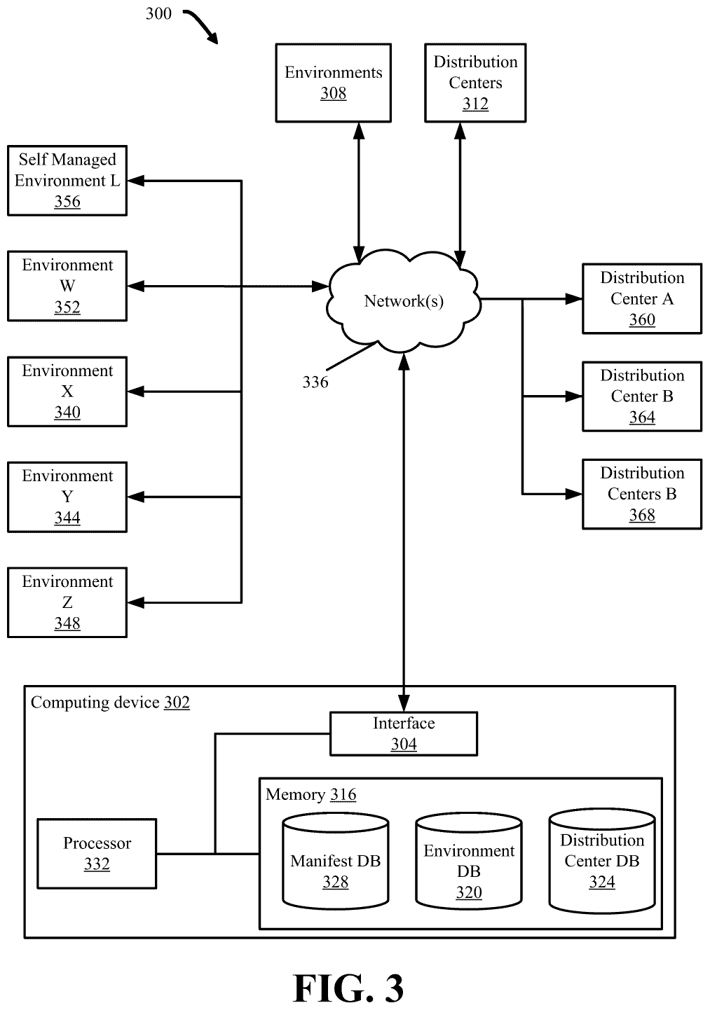

FIG. 3 illustrates a block diagram of an example system 300 configured to define hyperlocal networks by allocating independent environments to distribution centers according to aspects of the present disclosure. System 300 may include computing device 302 configured to provide middle-channel object distribution and consolidation services to environments, distribution environments, and/or distribution centers. Computing device 302 may include one or more interfaces through which information associated with remote environments may be processed. For example, interface 304 may include one or more input/output interfaces, network interfaces, application programming interfaces (APIs), and/or the like. Interface 304 may receive information associated with environments 308 and/or distribution centers 312. The information may include a physical location (e.g., street address, media access control address, etc.) of an environments/distribution centers, an identification of one or more devices associated with the environments/distribution centers and/or a communication interface through which the environments/distribution centers can be accessed, characteristics of environments/distribution centers (e.g., such as, but not limited to size, types of objects stored and/or provided by the environments/distribution centers, time intervals over which the environments/distribution centers operate, access credentials for communicating with environments/distribution centers (e.g., such as telephone numbers, email addresses, username/passwords, tokens, public/private keys, hashes, APIs etc.), metadata, and/or the like). In some instances, the information may be provided by an environment/distribution center (e.g., via email, a communication, etc.). In other instances, the information may be retrieved by system 300 such as through one or more API function calls, a data request, by an operator of the environment, by an operator of the distribution environment, by an operator of system 300 and/or the like.

System 300 may store the information received from environments 308 and/or distribution centers 312 and information derived by system 300 and corresponding to an environment and/or a distribution center in memory 316 one or more databases such as, but not limited to, environment database 320, distribution center database 324, manifest database 328. Environment database 320 may store information associated with independent environments, self-operated environments, and/or the like such as, but not limited to, physical address, virtual address (e.g., Internet Protocol address, communication interface and/or port addresses, etc.), types of objects stored and/or provided, an identification of a location within manifest database 328 that corresponds to manifest information of the environment, types of transmission supported by the environment (e.g., physical pick up, delivery, etc.), time interval over which the environment operates and/or is configured to distribute objects, timestamp corresponding to when the environment was instantiated, timestamp corresponding to when the environment was added to system 300 and/or allocated to a distribution center, metadata, a score (e.g., generated by the computing device, received from end users, one or more remote devices, etc.), a quantity of objects that that the environment is configured to provide for distribution or pickup (e.g., based on a historical average, an predicted average, etc.), and/or the like.

Distribution center database 324 may store information associated with distribution centers, distribution environments (e.g., a physical location storing and/or providing objects to end users, a platform including interfaces through which end users may generate object requests for pick up or transmission through distribution centers, distribution centers that store and/or distribute objects to end users such as those operated by the distribution environment those that store and/or distribute objects of the distribution environment), and/or the like such as, but not limited to, physical address, virtual address (e.g., Internet Protocol address, communication interface and/or port addresses, etc.), types of objects stored and/or provided, an identification of a location within manifest database 328 that corresponds to manifest information of the distribution environment, types of transmissions supported by the distribution center (e.g., physical pick up, delivery, etc.), time intervals over which the distribution environment operates, timestamp corresponding to when the distribution environment was instantiated, timestamp corresponding to when the distribution environment was added to system 300 and/or allocated to a logistical map, metadata, a score (e.g., generated by the computing device, received from end users, one or more remote devices, etc.), and/or the like Manifest database 328 may store storing information associated with objects stored and/or provided by environments, self-operated environments, distribution centers, distribution environments, and/or the like, such as, but not limited to, an identification objects stored and/or provided, an identification of a quantity of each object stored and/or available to be provided, characteristics of each object (e.g., size, mass, dimensions, a timestamp corresponding to a data of production and/or expiration, a graphical representation of each item (e.g., such as an image, two or three-dimensional model, etc.), metadata, and/or the like.

Computing device 302 may include one or more processors 332 configured to process incoming information from interface 304, execute instructions (e.g., those stored in memory 316, other memories not shown, from interface 304 such as remote procedure calls or API calls, etc.), facilitate communications with external devices through interface 304, and/or the like. For example, processor 332 may establish communications between computing device 302 and one or more environments and/or distribution centers through one or more networks 336.

Computing device 302 may identify for a particular distribution center one or more environments to allocate to the distribution center based on input received from interface 304, environments 308, distribution centers 312, and/or any of the databases of memory 316. Allocating an environment to a distribution center may enable the distribution center to provide objects of the environment to end users through a platform of the distribution center (e.g., such as an interface, website, etc.). Computing device 302 may coordinate transmission of objects requested by end users through the platform from an environment to the distribution center where the objects may be provided to the end user (e.g., through physical pickup, a last-channel delivery service, and/or the like). Computing device 302 may use one or more algorithms and/or machine-learning to determine which environments should be allocated to which distribution centers. For example, computing device 302 may extract features from data associated with the environment and/or the distribution center that may be predictive of a match between the environment and distribution center. Examples of such feature can include, but are not limited to, a location of the environment relative to the distribution center, a location of the environment relative to other distribution centers, an identification of objects provided by the environment, characteristics of objects provided by the environment (e.g., value, value history, quantity stored and/or available, size, mass, and/or the like), an identification of unique objects provided by the environment (e.g., those objects that are only provided by this environment, etc.), object storage capacity, time intervals over which the environment operates, time intervals over which the environment is capable of preparing objects for transmission, an identification of one or more routes between the environment and the distribution center over which objects may be transmitted, a quality and/or rank of each of the one or more routes (e.g., based on quantity of objects that can be transmitted, average transmission time, traffic, etc.), average timestamp in which objects from the environment are requested for transmission or requested to be delivered by, time intervals over which the distribution center operates, time intervals over which the distribution center offers last-mile delivery services, hours over which the distribution center offers physical pickup, and/or the like.

In some instances, the allocation of an environment to a distribution center may be fixed such that a single environment may be allocated to a single distribution center until the environment is allocated to another distribution center. In other instances, allocation of environments and distribution centers may be dynamically defined such that an environment may be allocated to one or more distribution centers at a same time. In those instances, a particular distribution centers may request objects from environments allocated to other distribution centers and/or environments that are not allocated to the particular distribution center. For example, a first environment may be allocated to a first distribution center. A second distribution center may determine that the first environment stores and/or provides a unique object (e.g., not provided by environment allocated to the second distribution center) and transmit a request to computing device 302 (and/or directly to the first environment) requesting the unique object.

System 300 may include and/or be connected to multiple environments. For example, independent environments (e.g., physical object distributors such as a shop, virtual platform such as website providing objects for transmission, and/or the like) such as environment X 340, environment Y 344, environment Z 348, environment W 352, etc., distribution centers such as distribution center A 360, distribution B 364 and distribution center B 368, etc., and self-managed environments (e.g., a location operated by computing device 302, operated by the middle-channel consolidation system that operates computing device 302, operated by an device and/or entity associated with computing device 302 or the middle-channel consolidation system, etc.) such as self-managed environment L 356.

Computing device 302 may define different designations for each environment. For example, may designate an environment as “singly allocated” (e.g., to one distribution center, etc.), “multi-allocated” (e.g., to one or more distribution centers, etc.) “inactive” (e.g., not allocated to any distribution centers, etc.), unallocated (e.g., not yet allocated to a distribution center, etc.), flexible (e.g., not allocated to a distribution centers, but distribution centers may request objects from the environment, etc.), and/or the like.

When an environment registers with system 300, the environment may transmit information associated with the environment (and/or the information may be transmitted via environments 308). In some instances, computing device 302 may establish an API-integration between an environment and computing device 302 to enable the computing device to retrieve information of the environment (e.g., such as any of the previously described information). Additionally, or alternatively, the API-integration may enable environments to retrieve information associated with distribution centers, which the environment is allocated to, object requests from distribution centers, hyperlocal network information (e.g., such as map 100 of FIG. 1), and/or the like. The API-integration may include one or more APIs exposed by computing device 302 and/or one or more APIs exposed by the environment.

When a distribution center registers with system 300, the distribution center may transmit information associated with the distribution center (and/or the information may be transmitted via distribution center 312). In some instances, computing device 302 may establish an API-integration between a distribution center and computing device 302 to enable the computing device to retrieve information of the environment (e.g., such as any of the previously described information). Additionally, or alternatively, the API-integration may enable environments to retrieve information associated with environments allocated to the distribution center, environments located with a same hyperlocal network as the distribution center (e.g., such as any information included in map 100 of FIG. 1), and/or the like. The API-integration may include one or more APIs exposed by computing device 302 and/or one or more APIs exposed by the distribution center.

Once registered, computing device 302 may allocate one or more environments to one or more distribution centers based on the one or more features and/or any information associated with the environment and/or the distribution centers. In some instances, the computing device may include one or more machine-learning models trained to allocate environments to distribution centers. The one or more machine-learning models may be trained using historical maps (e.g., such as map 100 of FIG. 1), historical data, procedurally generated data, manually generated data, and/or the like. The machine-learning models may be trained until one or more accuracy metrics associated with the machine-learning models reach or exceed threshold values (e.g., such as, but not limited to, accuracy, precision, recall, precision-recall curve, F1 score, receiver operating characteristic (ROC), confusion matrix, combinations thereof, or the like). The machine-learning models may include multivariate classifiers such as, but not limited to, neural networks, support vector machines, k-nearest neighbors, logarithmic regression, K-means, random forest, Naïve Bayes, and/or the like.

Once trained, computing device 302 may use the one or more features and/or features derived from any information associated with environments and distribution centers to generate an input feature vector. The machine-learning model may use the feature vector and output for each environment an identification of one or more distribution centers that the environment should be allocated and a confidence value for each of the one or more distribution centers. Computing device 302 may determine, based on the confidence values, whether to allocate the environment to the one or more distribution centers.

In some instances, computing device 302 may first allocate each environment to one distribution center (e.g., the distribution center having a highest confidence value and/or having a confidence value greater than a threshold confidence value). Computing device 302 may then determine if an environment should be allocated to additional distribution centers based on confidence values associated with those distribution centers being greater than the threshold confidence value. The machine-learning models may then determine a score associated with the allocation. The score may be generated sometime after the allocation have been executed such that data received from object requests, the environment, and/or the distribution centers may be used to determine a quality of the allocation to the distribution centers. The machine-learning models may use the score for reinforcement learning and/or to adjust the allocations associated with a particular environment and/or a distribution center. The machine-learning models may execute in regular intervals, upon registration of a new environment or distribution center, upon the occurrence of an event, based on user input, and/or the like to adjust the allocation of environments to distribution centers. In some instances, the machine-learning models may be further configured to generate hyperlocal networks and hyperlocal network maps based on the allocation of environments to distribution centers.

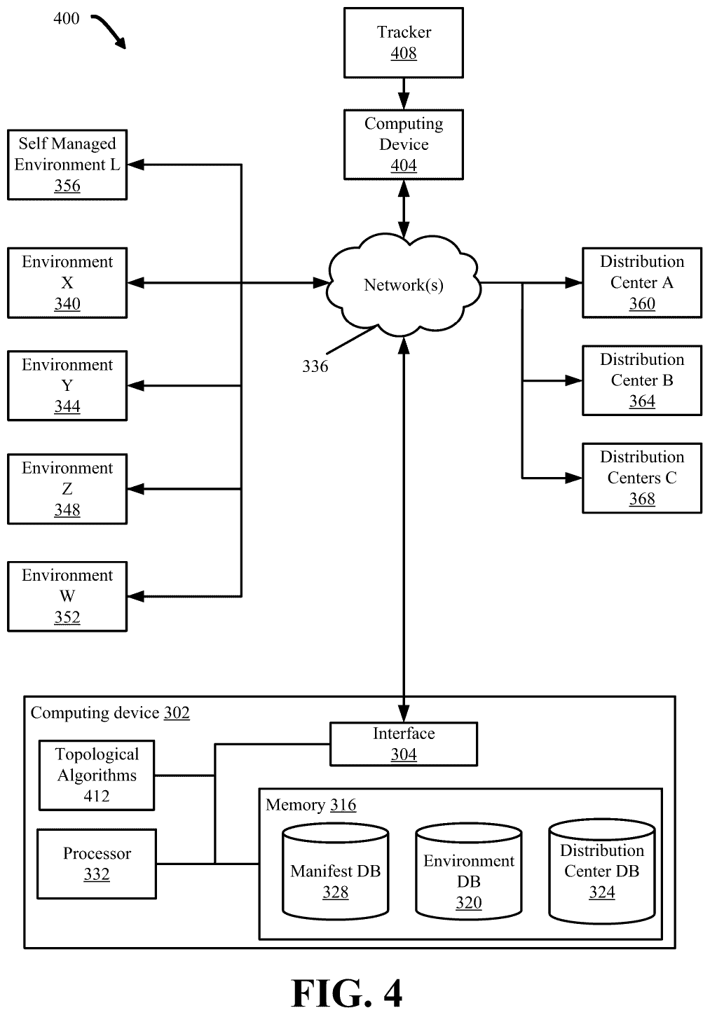

FIG. 4 illustrates a block diagram of an example system 400 configured to identify particular independent environments that satisfy object requests received from distribution centers according to aspects of the present disclosure. System 400 may include one or more components of system 300 as shown and/or one or more additional components.

Interface 304 may receive object requests from each of one or more distribution centers 368, computing device operated by an end user (e.g., such as mobile device, smartphone, desktop or laptop computer, etc.). In some instances, the object requests may be received a communication interface, through interaction with a webpage (e.g., operated by the distribution center, by a distributed environment of the distribution center by computing device 302, etc.), through interaction with an application (e.g., operated by the distribution center, by a distributed environment of the distribution center by computing device 302, etc.), and/or the like. Each object request may include an identification of one or more objects, an identification of a location to transmit the objects (e.g., the distribution center from which the object request is received, a self-managed environment, a particular environment, etc.), a time interval within which the objects are to be received by a distribution center and/or the end user, characteristics of the objects (e.g., value, size, mass, etc.), and/or the like. In some instances, when a time interval is not included in the object request or when the objects cannot be transmitted within the time interval provided by an object request, computing device 302 may generate a time interval within which the objects may be received by a distribution center and/or received by the end user. Computing device 302 may transmit the generated time interval to the distribution center.

An object request may include objects stored and/or provided by environments allocated to the distribution center that transmitted the object request. Computing device 302 may use manifests 328 to determine the environments that may provide the objects to satisfy the object request. When objects are stored and/or provided by more than one environment, computing device 302 may select the environment based on one or more factors such as, but not limited to, quantity of objects available by the environment, proximity to other environments that are provided objects to satisfy the object request and/or other object request within a same time interval, routes between environments that are providing objects to satisfy the object request and the distribution center, a computing device and/or delivery devices available to transmit the objects, a score associated with the environment (e.g., based on historical object requests, etc.), time of day, time of year, weather, and/or the like. Computing device 302 may then select the environments that may provide the objects to satisfy the object request. In some instances, computing device 302 may select the environments such that the fewest quantity of environments may be providing the objects to satisfy the object request. In other instances, computing device 302 may select the environments based on the time in which the object request can be satisfied (e.g., based on routes between environments and the distribution center, the time interval within which the object request is to be received by the distribution center and/or the end user, the location of computing devices 404 and/or associated vehicles providing transmission services, etc.

In still yet other instances, computing device 304 may select environments based on hyperlocal networks, designations assigned to environments, objects stored and/or provided by environments, an ability to satisfy an object request within the time interval, and/or the like. For example, environment X 340 and environment Y 344 may be allocated to (e.g., associated with) with distribution centers B 364 and distribution centers C 368. An object request received from distribution B 364 may be satisfied by object stored and/or provided by environment X 340 and/or environment Y 344.

Computing device 302 may verify that that objects stored and/or provided by an environment may be available for transmission. In some instances, computing device may retrieve the manifest associated with the environment from manifest database 328 or from an aggregated manifest (e.g., a manifest associated with a particular distribution center that includes the manifests of each environment allocated to that particular distribution center). Computing device 302 may determine if the objects are identified as being available in an inventory or manifest controlled or generated by the environment (e.g., through a communication and/or API function call, etc.). In some instances, the computing device may transmit a communication to the environment (e.g., via telephone, email, direct messaging, data messaging, and/or any other communication protocol) requesting confirmation that the objects (and the quantities thereof) are available to satisfy the object request.

Computing device 302 may determine whether to confirm object availability based on one or more factors that include, but are not limited to, a timestamp indicating when the manifest (in manifest database 328) was last updated, availability to communicate with servers of an environment, time of day, time of year, and/or the like.

In some instances, an object request may be transmitted to one or more distribution centers (e.g., such as distribution centers operated by a same distribution environment, etc.). In those instances, computing device 302 may determine whether the objects are to be transmit to a distribution center (e.g., and which distribution center that are to be transmitted to), a self-managed environment such as self-managed environment 356), or a particular environment. Computing device 302 may determine the transmission location based on multiple factors such as, but not limited to, the environments form which the objects are being transmitted, an identification of the distribution center from which the object request was received and/or identified by the object request, a hyperlocal network or map, previous object requests associated with the particular environment or route, previous object request transmitted to a distribution center, a location of the distribution center, time of day, time of year, weather, routes (e.g., received from topology algorithm 412), historical route characteristics (e.g., such as time interval over which the route was completed, quantity of times the route was traveled, etc.), computing device and/or delivery device available, location of computing device and/or delivery devices, user input, and/or the like.

Computing device 302 may then generate a route that includes the selected environments and the distribution center (or other delivery location). In some instances, computing device 302 may generate a graph from a hyperlocal network and/or logistical map that includes the selected environments and the distribution center. Computing device 302 may define each selected environment and the distribution center as a node within the graph. Alternatively, or additional, computing device 302 may define each intersection (e.g., on a map) as a node within the graph. Once the selected environments and the distribution centers are known, computing device 302 may assign a direction to each edge connecting each node to generate a directed graph. Weights may be assigned to each node and/or edge of the directed graph based on one or more factors (e.g., traffic associated with the nodes or edge, historical time intervals over which a computing device or delivery device traveled from one end of the edge to the opposing end of the edge or from a node to an adjacent node, time of day, time of year, weather, a current or anticipated location of a computing device and/or delivery device, etc.). The topology algorithm may then define a transmission route using the directed graph that reaches each the selected environments and the distribution center within the time interval of the object request. In some examples, such a route may be defined using Dijkstra's algorithm or the like.

More than one route may be generated for the object request based on any of the aforementioned factors (e.g., by adjusting the weights assigned to each edge and/or node). Computing device 302 may define various alternative routes making various assumptions (e.g., for weather, traffic, road/edge closures, etc.). A particular route may then be selected when object transmission is to commence and/or by the computing device/delivery device that will be transporting the objects from the environments to the distribution center.

In other instances, the directed graph (or the features used to derive the directed graph) may be input into a machine-learning model trained to generate routes. The machine-learning model may output one or more routes with one or more corresponding confidences. The route having a highest confidence may be selected with the other routes being stored as alternatives should a problem arise with the selected route. A particular route may then be selected when object transmission is to commence and/or by the computing device/delivery device that will be transporting the objects from the environments to the distribution center and based on conditions of the hyperlocal network when object transmission is to commence.

Once the objects are received at the delivery location, computing device 302 (and/or computing device or delivery device) may score the route and/or the transmission and use the score for reinforcement learning and/or to further improve topology algorithms 412.

Computing device 302 may generate a specification based on the selected environments and the distribution center (or other delivery location), the selected route and/or any alternative routes, and the current location of computing device 404 or delivery device. Computing device 404 may be device operated by an entity configured to retrieve objects from environments and convey the objects to the distribution center (or other delivery location). For example, computing device 404 may be mobile device operating an app that is configured to communicate with computing device 302. Delivery device may include a device configured to transport objects between location such as, but not limited to, a drone (e.g., operated by computing device 404, another device, an entity, or by an automated process), a two-wheeled vehicle such as a scooter, a four-wheeled vehicle such as a car or truck, and/or the like. Computing device 404 and/or the delivery device may include tracker 408 (e.g., a physical device or software configured to store and/or transmit a current location of computing device 404 and/or the delivery device). An example of such a tracker is a global position system (GPS) or the like.

The specification may be transmitted to the selected computing device 404 and/or delivery device that will be transmitting the objects. In some instances, the specification may be transmitted to some or all computing devices 404 and/or delivery devices in a same geographical area. In those instances, the first computing device 404 and/or delivery device to acknowledge receipt of the specification may then execute the specification and transmit the objects. Once an acknowledgement is received, computing device 302 may transmit a confirmation to the computing devices 404 and/or delivery devices that the specifications was transmitted to prevent multiple devices from attempting to satisfy the same object request.

Computing devices 404 and/or the delivery device may then execute the specification by retrieving the objects from the selected environments and providing those objects to distribution center (or other delivery location), where the objects will be consolidated with other objects received from other environments (if the object request was satisfied by more than one computing device 404 and/or delivery device, etc.) and other objects provided by the distribution center that are to be distributed to the end user to form a package. The distribution center may then facilitate distribution of the package to the end user (e.g., using a last-channel delivery service of the distribution center) and/or coordinating with the end user to pick up the package.

In some instances, computing device may suggest an alternative location from which the objects of the object request may be retrieved by the end user (e.g., such as a particular environment, a self-managed environment, a different distribution center, etc.) or otherwise delivered to the end user. Computing device 302 may transmit a communication to the end user (e.g., through an app executing on a device of the end user, through a webpage of the distribution center that transmitted the object request, through an email, text messaging, direct messaging, through a telephone connection, and/or the like). For example, if computing device 404 was unable to transmit the objects to the distribution center (e.g., due to lack of time, traffic, weather, etc.), computing device 302 may suggest an alternative location from which the objects may be retrieved. The suggestion may include those objects provided by the environments, the full object request (e.g., including those objects to be provided by the distribution center, etc.), one or more time intervals over which the objects may be retrieved, and/or the like.

When the specification is generated, a communication may be transmitted to each of the selected environments indicating a time interval within which the objects to be provided by the environments are to be prepared for transmission (e.g., set aside, labeled, packaged, etc.) or transmitted. Computing device 302 may transmit additional and/or alternative communications to environments indicating a progress of the object request (e.g., such as when computing device 404 and/or the delivery device begins to execute the specification or otherwise anticipates arrival at an environment, etc.). The status of the distribution request may be updated continuously (e.g., in real time) or in batch processes (e.g., in regular intervals) and stored in memory 316. An API may expose the status data such that environments, distribution centers, and/or the end user may access the status to determine a location of each object of the object request.

When the objects are received at the distribution center (or the other destination location), computing device 302 may transmit a communication to the distribution center and/or the end user including an indication that the objects have been received by the distribution center (or other destination location). The distribution center may then consolidate the objects and distribute (or otherwise provide) the objects to the end user (as previously described).

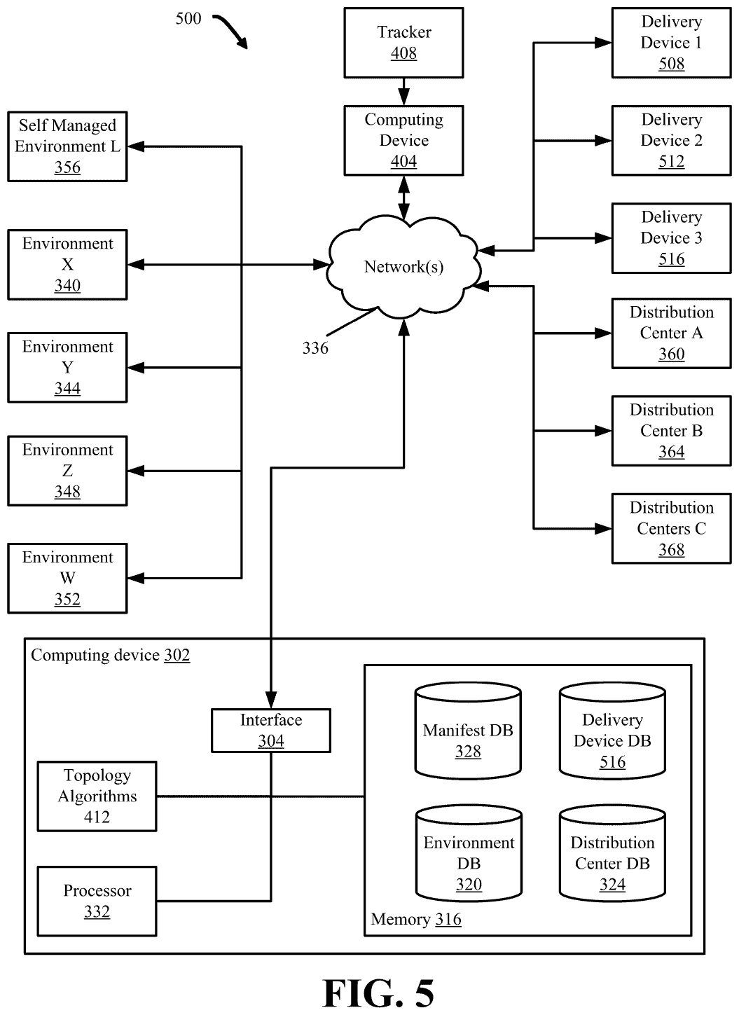

FIG. 5 illustrates a block diagram of an example system 500 configured to define dynamic routes between independent environments and distribution centers according to aspects of the present disclosure. System 500 may include one or more components of system 300 and/or system 400 as well. System 500 may include one or more additional components of system 300 and/or system 400 or may omit some components of system 300 and/or system 400.

Computing device 302 may track computing device 404 and/or the deliver devices positioned with a hyperlocal network and configured to facilitate the transmission of objects from environments to distribution centers. Computing device 302 may define routes for computing device 404 and/or the delivery devices to efficiently reach the environments from which objects are being transmitted. In some instances, distribution centers may dispatch computing device 404 and/or the delivery devices when an object request is received. In other instances, such those in which large quantities of object requests are generated, computing device 404 and/or the delivery devices and may execute one or more routes with a predetermined frequency each time interval (e.g., such as a day, week, month, etc.). For example, computing device 404 may retrieve objects from a particular set of environments using a same route multiple times a day.

Computing device 404 and/or the delivery devices may be tracked using a tracking system embedded in software and/or hardware of computing device 404 and/or the delivery devices (e.g., such as GPS, radio triangulation, etc.). The location of each computing device 404 and/or the delivery devices may be stored in delivery database 504. Delivery device database 516 may expose the data to one or more APIs to enable environments, distribution centers, distribution environments, end users, other computing devices 404, other delivery vehicles, and/or the like to identify the location of computing device 404 and/or the delivery devices.

In some instances, only those entities associated with an object request being satisfied by computing device 404 and/or the delivery devices may receive and/or otherwise obtain the tracking data associated with computing device 404 and/or the delivery devices. In those instances, the tracking data may be encrypted and/or obfuscated (e.g., using a cryptographic or hashing function). The key may be transmitted to devices associated with the current object request being satisfied by computing device 404 and/or the delivery devices (e.g., those environments where objects are being transmitted by computing device 404 and/or the delivery devices, the distribution center that transmitted the object request, the end user that generated the object request, etc.). Alternatively, a token (e.g., a hash value of the at least a portion of the object request) may be given to the devices associated with the current object request being satisfied by computing device 404 and/or the delivery devices. Computing device 302 may request the token be included with any request for location data. The key and/or token may be configured to expire to prevent the data from being accessible once the object request has been completed.

Delivery device database 516 may store route information (associated with tracking data if available) for a predetermined time interval after the object request has been completed. In some instances, such as when tracking data is not available, the historical data may be used to determine a location of computing device 404 and/or the delivery devices. Since computing device 404 and/or the delivery devices may travel along a same route many times, the historical data may be used to determine a likely location of computing device 404 and/or the delivery devices along a particular route at a given time. In some instances, a machine-learning model (e.g., such as a classifier) may be trained to predict a current or future location of computing device 404 and/or the delivery devices using the historical data. In some instances, the tracking data may be used to label the historical data to train the machine-learning model using supervised learning.

Topology algorithms 412 may be use the current and/or historical location of computing device 404 and/or the delivery devices when generating routes for computing device 404 and/or the delivery devices for a particular object request. In some examples, computing device 302 may generate a directed graph from a hyperlocal network and/or logistical map that includes the environments having objects for transmission and the distribution center, which is to receive the objects. Weights may be assigned to each node and/or edge of the directed graph based on one or more factors that include (in addition those previously described) the current or expected location of computing device 404 and/or the delivery devices when the object request is to be satisfied. The topology algorithm may then define a transmission route using the directed graph that reaches each the selected environments and the distribution center within the time interval of the object request. In some examples, such a route may be defined using Dijkstra's algorithm or the like.

More than one route may be generated for the object request based on any of the aforementioned factors (e.g., by adjusting the weights assigned to each edge and/or node). Computing device 302 may define various alternative routes making various assumptions (e.g., for weather, traffic, road/edge closures, etc.). A particular route may then be selected when object transmission is to commence and/or by the computing device/delivery device that will be transporting the objects from the environments to the distribution center.

In other instances, the directed graph (or the features used to generate the directed graph) may be input into a machine-learning model trained to generate routes. The machine-learning model may output one or more routes with one or more corresponding confidences. The route having a highest confidence may be selected with the other routes being stored as alternatives should a problem arise with the selected route. A particular route may then be selected when object transmission is to commence and/or by the computing device/delivery device that will be transporting the objects from the environments to the distribution center and based on conditions of the hyperlocal network when object transmission is to commence.

Computing device 302 (and/or computing device 404 or the delivery device) may score the route and/or the transmission and use the score for reinforcement learning and/or to further improve topology algorithms 412.

The selected route (and optionally any alternative routes), an identification of the objects to be transmitted and/or the object request, characteristics of the objects being transmitted (e.g., size, mass, a representation such as an image, color, etc.), a time interval within which the objects are to be received by computing device 404 and/or the delivery devices or received at the distribution center, and/or the like may be used to generate a specification. The specification may be transmitted to computing device 404 (e.g., the device in use by and/or proximate to the operator of the delivery device) and/or the delivery device. In some instances, each delivery device may receive the specification and the first device to acknowledge the specification may be configured to execute the specification. For example, the specification may be transmitted to delivery device 508, delivery device 512, and delivery device 516. In other instances, the specification may be transmitted to a single computing device 404 and/or delivery device being operated to transmit the objects (e.g., just delivery device 508).

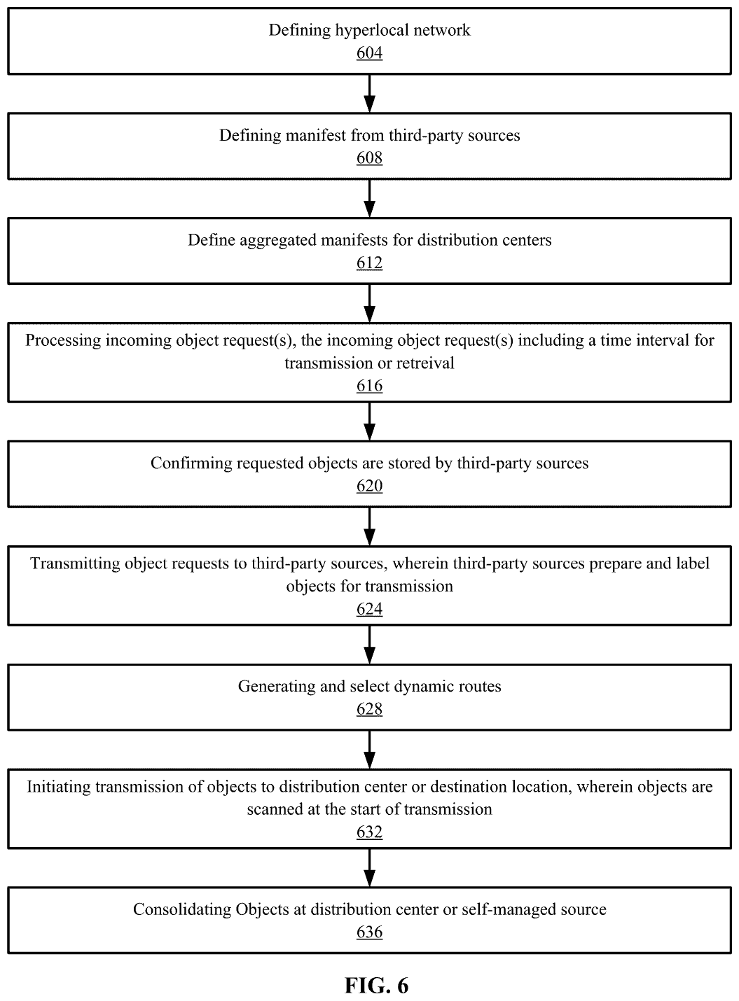

FIG. 6 illustrates a flowchart of an example method of consolidating independent-environment sourced objects with primary objects of an object request at distribution centers according to aspects of the present disclosure.

At block 604, a computing device a hyperlocal network. The hyperlocal network may include one or more independent environments, self-managed environments, one or more distribution centers, and/or the like. In some instances, the hyperlocal network may include one or more map features (e.g., a topology, landmarks, etc.). The computing device may allocate each of the one or more independent environments to the one or more distribution centers to enable the distribution centers to provide the objects stored and/or provided by the independent environments allocated to it to end users. The hyperlocal network and/or the allocation of independent environments to distribution centers may be performed as previously described.

At block 608, the computing device may define a manifest for each of the one or more independent environments based in manifest data received from the independent environment. The manifest may include an identification of one or more objects stored and/or provided by the independent environment, a quantity each type of object stored and/or provided, characteristics of the one or more objects, metadata, a timestamp associated with when the manifest data was received by the computing device.

At block 612, the computing device may define one or more aggregated manifest for distribution centers. In some instances, the aggregated manifest may include the manifest of each of the one or more independent environments and the one or more distribution centers. Additionally, or alternatively, the computing device may define an aggregated manifest for each distribution center that includes the manifest of only those independent environments allocated to that distribution center. This aggregated manifest may also include one or more objects provided by other independent environments that may not be allocated to the distribution center, but that may be available under certain circumstances (e.g., a higher value is provided for the object request, an emergency, and/or other special events). The computing device may transmit the manifest or aspects thereof to the distribution center as an indication of what objects of the independent environment may be included in object requests.

At block 616, the computing device may receive an object request from an end user (e.g., operating a website and/or an app executing on a computing device) or a distribution center that includes one or more objects stored and/or provided by one or more independent environments. The object request may include an identification of the one or more objects, destination location (e.g., the distribution center, the self-managed environment, an independent environment, and/or the like), a time interval within which the object request is to be satisfied (e.g., transmitted to the destination location or received by the end user, etc.).

At block 620, the computing device may confirm the object request by transmitting a communication to the device that transmitted the object request, the destination location, the end user, and/or the like. The confirmation may include any of the information in the object request with an indication that the object request is being satisfied within the time interval. If the computing device determines that the object request cannot be satisfied within the time interval, the computing device may indicate one or more alternatives in the confirmation such as one or more alternative time intervals, one or more alternative destination locations (e.g., such that the original time interval can be accommodated or closely accommodated, etc.). The computing device may select an alternative and continue processing the object request (unless a response selecting a different alternative or a cancelation is received). Alternative, the computing device may wait until an alternative is selected before continuing to process the object request.

At block 624, the computing device may transmit communications to each of the independent environments from which objects may be obtained to satisfy the object request. In some instances, the computing device may select independent environments (if more than one may provide the objects identified in the object request) that are allocated to the distribution center that transmitted the request and/or will receive the objects based on one or more factors. Examples of such factors include, but are not limited to, a value of the objects, a location of the independent environment relative to the distribution center or destination location, a location of other independent environments relative to the independent environments that may providing objects for the object request, anticipated routes that may be used to retrieve the objects and/or transmit the objects, weather, time of day, time of year, anticipated traffic, a score assigned to the independent environments, combinations thereof, or the like.

The computing device may be configured to weight the factors based on a relative importance of each factor. In some instances, a value of the object may be weighted higher than other factors. In other instances, the factors associated with the shortest or quickest route (e.g., anticipated traffic, relative location to other independent environments that will be providing objects for the object request, weather, route, etc.) may be weighted higher than other factors. The computing device may dynamically adjust the weights based on the current (real time) characteristics of the computing device, hyperlocal network, and/or the like. For example, the computing device may weight object value higher when the time interval within which the objects are to be received at the destination location is longer (e.g., greater than 24 hours, etc.). and weight factors that correspond to the speed with which the object request may be satisfied when the time interval within which the objects are to be received at the destination location is shorter (e.g., less than or equal to 12 hours, etc.).

The computing device may adjust the timing thresholds (for independent environment selection) based on historical object requests, user input, a current status of independent environments or the distribution center, a current status of the hyperlocal network, combinations thereof, or the like.

The communications transmitted to the selected independent environments may include any information object request associated with the objects stored and/or provided by the independent environment. The communication may include a time interval within which those objects are to be prepared for transmission (e.g., set aside, labeled, packaged, etc.).

At block 628, the computing device may generate one or more dynamic routes to satisfy the object request. The quantity of dynamic routes selected may be based on similar factors as those used to select the independent environments (e.g., weighting in favor of reducing an overhead by reducing the quantity of routes to be traveled, weighting in favor of speed with which the object request may be satisfied, etc.). The dynamic routes may be generated by one or more topology algorithms as previously disclosed. Alternatively, or additionally, the computing device may include one or more machine-learning models configured to generate a dynamic route. The machine-learning models may be trained using historical object requests, procedurally generated data, manually generated data, and/or the like. The machine-learning models may also output a confidence value and the computing device may select the dynamic route associated with the highest confidence.

In some instances, a dynamic route may include a route from a starting location, to one or more independent environments, and to a destination location. In some instances, a dynamic route may be dynamically adjusted (e.g., in real time or upon detection of an event, etc.). For example, if the computing device and/or (the delivery device) determines that an edge of the route has been closed or is otherwise unusable or that travel along an edge would cause a transmission time to exceed a threshold time interval, etc., the route may be automatically adjusted based on the current location of the delivery device and/or the edge to be replaced. The adjusted route may be one that avoids the edge to be replaced or otherwise enables completion of the object request within the time interval.

At block 632, the computing device initiates transmission of objects to distribution center or destination location. The computing device may transmit a specification to one or more computing devices associated with a delivery operator or to a delivery device that includes the dynamic route to be traveled by the one or more computing devices and/or the delivery device, an identification of the objects to be received at each independent environment along the route, characteristics of the objects, and/or the like. The computing device may receive (e.g., before, during, or after generating or transmitting the specification) and indication the objects of the object request have been scanned (e.g., prepared for transmission) from each independent environment providing objects for the object request or from the computing devices associated with a delivery device.

Once the specifications are transmitted to the one or more computing devices associated with a delivery operator or to a delivery device, the specifications may be executed causing the delivery device that received the specification (or its operator) to travel along the dynamic route, obtain the objects, and transmit the objects to the distribution center and/or destination device. In some instances, the computing device may include more than specifications for a particular object request (e.g., based on the relative locations of the independent environments, a size of the delivery device, other object requests to be satisfied by the delivery devices, time interval within which the objects are to be transmitted to the destination location or received by the end user, combinations thereof, and/or other factors). In those instances, a first specification may be executed by a first delivery device and a second specification may be executed by a second delivery device, etc. The computing device may generate any number of specifications for a particular object request causing any number of delivery devices to operate in parallel to satisfy the object request.

At block 636, the objects may be received at the distribution center or destination location and consolidated with other objects provided by other delivery devices (and correspond to the same object request), other objects being provided by the distribution center and/or destination location (and included in the object request generated by the end user), and/or other objects requested by the end user. The consolidated objects may be packaged and provided to the end user through a last-channel delivery service operated by the distribution center or destination location. Alternatively, the package may be made available for pick up by the end user at the distribution center, destination location, a self-managed environment, an independent environment, and/or the like.

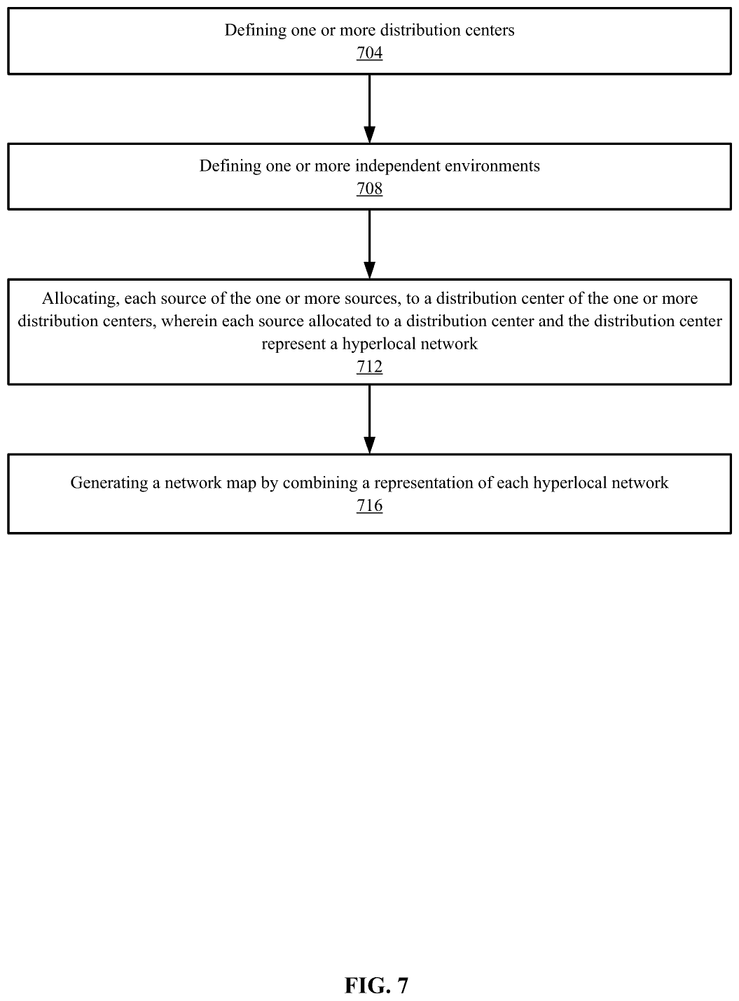

FIG. 7 illustrates a flowchart of an example method of generating hyperlocal networks based on independent environments allocated to distribution centers according to aspects of the present disclosure.

At block 704, a computing device may receive information corresponding to one or more distribution centers. Examples of the information that may be received includes, but is not limited to, physical address, virtual address (e.g., Internet Protocol address, communication interface and/or port addresses, etc.), an identification of a communication interface and/or platform usable to access data of the distribution center, types of objects stored and/or provided by the distribution center, an identification of a manifest corresponding to objects distributed or provided by the distribution center, types of transmissions supported by the distribution center (e.g., physical pick up, delivery, etc.), time intervals over which the distribution center operates, timestamp corresponding to when the distribution center was instantiated, timestamp corresponding to when the distribution environment was registered with the computing device, metadata, a score (e.g., generated by the computing device, received from end users, one or more remote devices, etc.), an identification of historical object requests, and/or the like.

The computing device may register the distribution center using some or all of the information provided. Registering the distribution center may include generating a data structure corresponding to the distribution center and a globally unique identifier (GUID) for the distribution center. In some instances, the GUID may be generated using a hashing function and some or all of the information received.

The computing device may then establish communications with the distribution center (e.g., direct communications, email or other text-based communication, data-based communications, programmatic-based communications through one or more APIs, telephonic, etc.). In some examples, once registered, the computing device may be configured to present information to end users through a platform of the distribution center (e.g., such as a website, server, or the like) by, for example, using JavaScript and/or other side-executed instructions embedded into the platform. Instructions within the platform may execute to obtain information from the computing device (and/or a server or database of the computing device, etc.), when the platform is loaded by an end user. Alternatively, the information may be transmitted from the computing device (and/or a server or database of the computing device, etc.) to the distribution center and the distribution center may present the information through the platform.

At block 708, the computing device may receive information corresponding to one or more independent environments (e.g., physical locations storing and/or providing objects and/or a virtual platform such as a website through which objects may be provided, etc.). Examples of information received may include, but is not limited to, a physical address of the independent environment, a virtual address of the independent environment (e.g., Internet Protocol address, communication interface and/or port addresses, etc.), an identification of a communication interface and/or platform through which the computing device can access information of the independent environment or communicate with the independent environment, types of objects stored and/or provided by the independent environment, a manifest of the independent environment, types of transmissions supported by the environment (e.g., physical pick up, direct delivery, etc.), time intervals over which the environment operates and/or is configured to distribute objects, timestamp corresponding to when the environment was instantiated, timestamp corresponding to when the environment was registered with the computing device, metadata, a score (e.g., generated by the computing device, received from end users, one or more remote devices, etc.), a quantity of objects that that the environment is configured to provide for distribution or pickup (e.g., based on a historical average, an predicted average, etc.), and/or the like.

The computing device may register the independent environment using some or all of the information provided. Registering the independent environment may include generating a data structure corresponding to the independent environment and a globally unique identifier (GUID) for the independent environment. In some instances, the GUID may be generated using a hashing function and some or all of the information received. In other instances, the GUID may be generated or obtained from the information received.

The computing device may then establish communications with the independent environment (e.g., direct communications, email or other text-based communication, data-based communications, programmatic-based communications through one or more APIs, telephonic, etc.). In some examples, once registered, the computing device may be configured to obtain information from a platform of the independent environment (e.g., such as a from a website, server, or the like). The computing device may retrieve information programmatically (e.g., through APIs exposed by the independent environment and/or the computing device, etc.), manually, by transmitting an information request, and/or the like.

At block 712, the computing allocates independent environments (e.g., some or all of the independent environments), to a distribution center of the one or more distribution centers. The computing device may extract features from the information associated with the independent environments and/or the distribution centers. Examples of such feature can include, but are not limited to, a location of the environment relative to the distribution center, a location of the environment relative to other distribution centers, an identification of objects provided by the environment, characteristics of objects provided by the environment (e.g., value, value history, quantity stored and/or available, size, mass, and/or the like), an identification of unique objects provided by the environment (e.g., those objects that are only provided by this environment, etc.), object storage capacity, time intervals over which the environment operates, time intervals over which the environment is capable of preparing objects for transmission, an identification of one or more routes between the environment and the distribution center over which objects may be transmitted, a quality and/or rank of each of the one or more routes (e.g., based on quantity of objects that can be transmitted, average transmission time, traffic, etc.), average timestamp in which objects from the environment are requested for transmission or requested to be delivered by, time intervals over which the distribution center operates, time intervals over which the distribution center offers last-mile delivery services, time intervals over which the distribution center offers physical pickup, scores associated with the environment and/or the distribution centers, and/or the like.

The computing device may weight the features based on one or more factors of the computing device when allocating environments. In some instances, the computing device may weight features indicative of unique objects higher than other features such that a distribution center may provide a larger variation of objects to end users. In some instances, the computing device may weight features indicative of a speed or rate in which object requests can be satisfied higher than other features such that the computing device may favor environments that can satisfy object requests quickly when allocating environments to a distribution center. In those instances, a location of the independent environment relative to the distribution center may be weighted higher than other features such that the independent environments closer to the distribution center may be more likely to be allocated to the distribution center. In some instances, the distribution center may define the weights assigned to features such that the distribution center may determine the types of environments more likely to be allocated to a particular distribution center.

Any number of independent environments may be allocated to any number of distribution centers based on the features. In some instances, each independent environment may be allocated to one or more distribution centers. In other instances, some independent environments may be allocated to one or more distribution centers (e.g., with one or more independent environments may not be allocated to any distribution centers, etc.).

The computing device may define a hyperlocal network from at least one distribution center the one or more independent environments allocated to that distribution center. In some instances, the computing device may define hyperlocal networks based on a limited geographical location. In those instances, the hyperlocal network may include one or more distribution centers that are positioned within the limited geographical location (whether or not the distribution centers are operated by and/or used by a same distribution environment) and those independent environments allocated thereto. In other instances, the computing device may define hyperlocal networks based on a distribution environment that operates one or more distribution centers. In those instances, the computing device may define a hyperlocal network that includes the distribution centers operated by and/or used by a same distribution environment and those independent environments allocated thereto.

At block 716, the computing device defines a network map by combining the representation of one or more hyperlocal networks. In some instances, the computing device may combine each hyperlocal network such that the map includes each distribution center registered with the computing device and those independent environments allocated thereto. In some instances, the map may be augmented to include independent environments that are not allocated to a distribution center, self-managed environments, topology, landmarks, an identification of routes between independent environments, an identification of routes between independent environments and distribution centers, an identification of routes between distribution centers, historical traffic data, real time traffic data, combinations thereof, or the like.

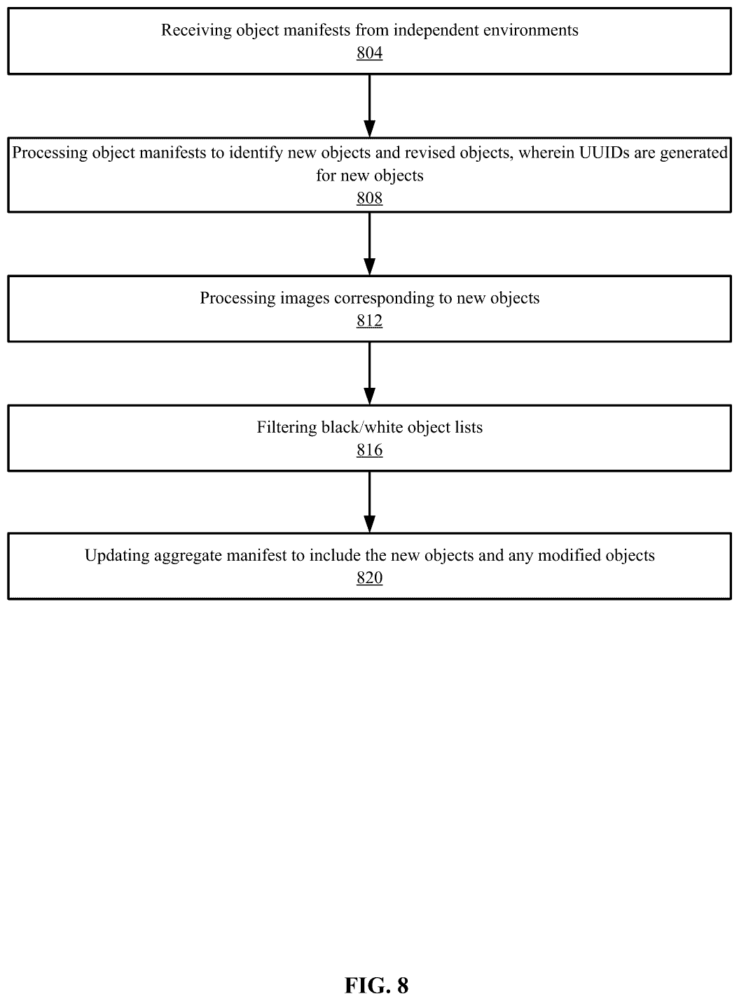

FIG. 8 illustrates a flowchart of an example method of defining aggregated object manifests according to aspects of the present disclosure.

At block 804, a computing device may receive object manifests from one or more independent environments. The computing device may receive the object manifests from a communication from an independent environment (e.g., as a comma separated variable, extensible markup language, JavaScript object notation, and/or other data format, etc.). Alternatively, the computing device may retrieve the object manifest from the independent environments and/or from another remote device via one or more APIs, local storage, a database or server, a website of the independent environment, a file transport protocol, simple object access protocol, and/or the like. The object manifests may include an identification of objects provided by the independent environment, a type associated with each object, characteristics of each object (e.g., size, mass, current and/or historical value, appearance information such as color or shape, etc.), a quantity of each object that the independent environment is storing and/or configured to provide, a representation of each object (e.g., an image, two or three-dimensional model, etc.), any other information associated with an object, combinations thereof, or the like. The manifest may include an initial manifest (e.g., the first manifest received from a particular independent environment) or an updated manifest (e.g., current manifest from an independent environment, that is to supplement and/or replace a previously received manifest from the independent environment).

At block 808, the computing device may process the object manifests from each of the one or more independent environments. Processing the manifests may include generating a universally unique identifier (UUID) for each object type (e.g., an object of a particular brand). The computing device may iterate over each manifest and determine for each object whether the object type has already been processed by the computing device (e.g., from a previously received manifest from that independent environment and/or from another independent environment, etc.). If so, the object may be assigned to the UUID of the previously processed object of the same type and the computing device increments a quantity associated with the object type stored by the computing device based on the quantity of the object identified in the manifest (e.g., such that the computing device includes a quantity of each object type across the object manifests). If not, the computing device generates a UUID for the new object (e.g., using a hashing function and one or more features derived information associated with the object such as an object name or other identifier) and stores the UUID with information associated with the object.

In some instances, the computing device may augment the information provided by the manifests. The computing device may use current and/or historical information stored by and/or accessible to the computing device that corresponds to the objects of a manifest. For example, the computing device may identify characteristic information for an object (for which characteristic information was not included in the corresponding manifest) from local memory, a server, a database, webpage, etc. and store the characteristic information in association with the object. The computing device may retrieve any information associated with an object from the independent environment and/or from any other source.

At block 812, the computing device may process representations of the new objects. The manifest may include a representation of each object (or only those objects that are new or otherwise not identified by the computing device). The representation may include image data, two or three-dimensional models, audio and/or video data, etc. The computing device may store the representation of each new object with information associated with the object. In some instances, the representation of the object may be transmitted to one or more other devices to enable a presentation of the representation of the objects to end users.

At block 816, the computing device may filter objects based on white and/or blacklists. The computing device may maintain whitelists and/or blacklists for each distribution center and/or for each independent environment. For a distribution center, a whitelist may include objects that the distribution center will provide to end users. For an independent environment, a whitelist may include objects that the independent environment will provide to distribution centers. The whitelist may include an identification of objects and/or an identification of object quantities. For a distribution center, a blacklist may include objects that the distribution center will not provide to end users. For an independent environment, a blacklist may include objects that the independent environment will not provide to distribution centers. The blacklist may include an identification of objects (e.g., by UUID or other identifier) and/or an identification of object quantities. For example, the whitelist and/or blacklist may be used to determine a quantity of a particular object that an independent environment will provide to satisfy object requests received from distribution centers.

The whitelists and/or blacklists may be defined by a respective independent environment and/or distribution center or by the computing device. In some instances, the whitelists and/or blacklists may be defined based on characteristics of an object. For instances, if the value of an object is higher at one independent environment than another independent environment, the computing device may blacklist the object from the first independent environment.

At block 820, the computing device may generate an aggregated manifest based on the processed manifests and application of the whitelist and blacklist filters. In some instances, the computing device may generate an aggregated manifest for each distribution center that includes an identification of those objects stored and/or provided by the independent environments allocated to that distribution center (and/or are otherwise available to the distribution center). In other instances, the computing device may generate a master manifest that includes the information from each manifest (e.g., after being processed and filtered). The aggregate manifest may include an identification of one or more objects, a quantity of each of the one or more objects, an identification of the independent environments storing and/or providing the one or more objects, characteristics of the one or more objects, representations of the one or more objects, and/or the like as received from the independent environment, as augmented by the computing device, as processed by the computing device, and/or the like.

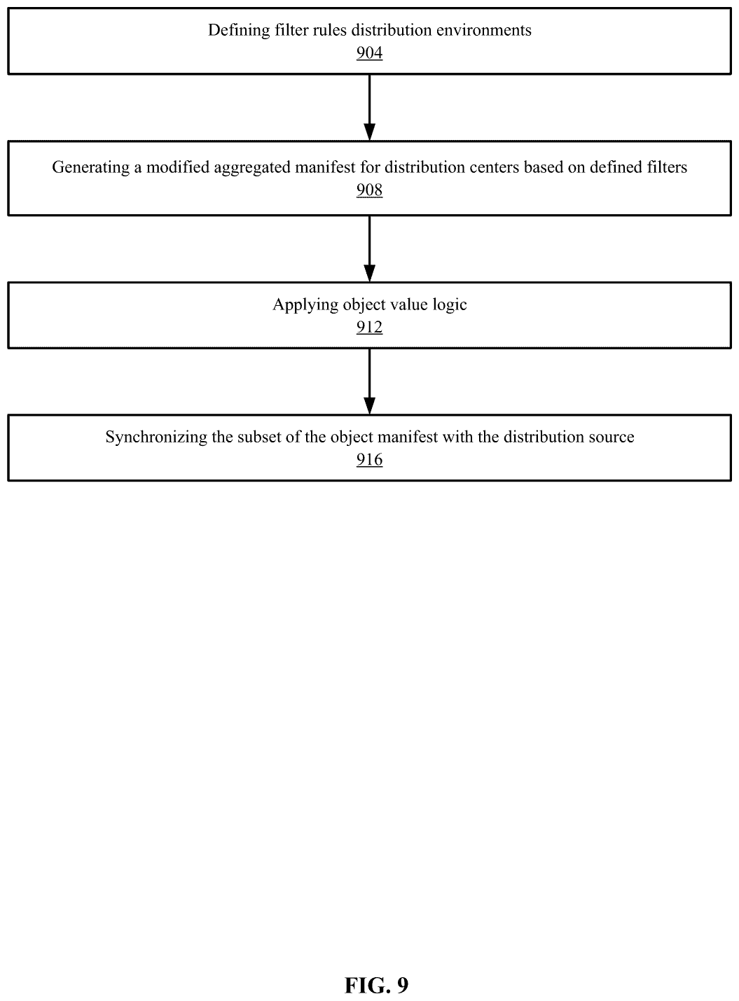

FIG. 9 illustrates a flowchart of an example method of integrating manifests generated from independent environments into a primary object distribution platform of an distribution center according to aspects of the present disclosure.

At block 904, the computing device defines filter rules a distribution environment. The filter rules may be applied to an aggregated manifest that corresponds to the distribution centers operated by the distribution environment (or the object manifests received from those independent environments allocated to the distribution centers) to determine which objects of the aggregated manifest will be provided by the distribution centers, how the aggregated manifest can be represented by a platform of the distribution center, a frequency with which the aggregated manifest may be updated, and/or the like. The filter rules may be automatically defined by the computing device, received from the distribution environment, based on user input, based on independent environments that store and/or provide objects of the aggregated manifest, and/or the like.

At block 908, the computing device applies the filter rules to the aggregated manifest to generate a modified aggregated manifest.

At block 912, the computing device applies value logic to the aggregated manifest. The value (e.g., price, etc.) of an object may be determined by the computing device based on a value of the object set by the independent environment storing and/or providing the object (as per the modified aggregated manifest) and an additional value added by the computing device. The computing stores the derived value of each object in the aggregated object manifest.

At block 916, the computing device synchronizes the modified aggregated manifest with the distribution centers. The computing device may transmit the modified aggregated manifest to the distribution centers to notify the distribution centers as to which objects are available to provide to end users and a quantity of those objects that are available. Alternatively, the computing device may store the modified aggregated manifest in a network accessible location (e.g., via a universal resource locator, or the like). The distribution environment may embed instructions in a webpage or application linked to the network accessible location to access the information of the modified aggregated manifest.

In some instances, the modified aggregated manifest (or a portion thereof) may be transmitted to independent environments as a confirmation as to the information provided to distribution centers. The independent environments may transmit communications to revise and/or correct the information and a revised modified aggregated manifest may then be provided to the distribution centers.

The computing device may further modify the modified aggregated manifest based on additional information received from independent environments (e.g., such as updated manifests, etc.), object requests being completed, and/or the like. The computing device may remove objects from the modified aggregated manifest, adjust a quantity of an object in the modified aggregated manifest, modify characteristics of an object, and/or the like. The computing device may further modify the modified aggregated manifest each time an object request is completed and/or in regular intervals. If the modified aggregated manifest is stored in a network accessible location, no further processing may be needed. If the modified aggregated manifest is not stored in a network accessible location, the computing device may transmit a notification or other communication to the independent environments and/or the distribution centers that includes the modified aggregated manifest or a delta data structure. The delta data structure may correspond to the difference between the original modified aggregated manifest and the further modified aggregated manifest.

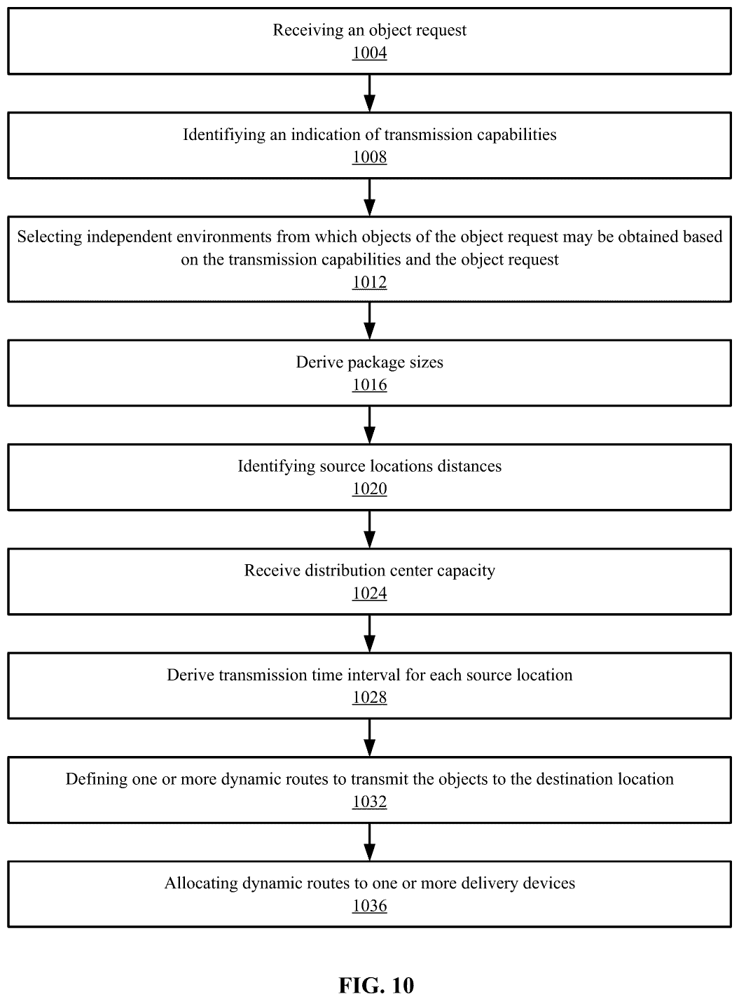

FIG. 10 illustrates a flowchart of an example method of transmitting specifications to delivery devices configured to facilitate the transmission of objects from independent environments to distribution centers according to aspects of the present disclosure.

At block 1004, a computing device may receive an object request that includes an identification of one or more objects to be provided by one or more independent environments and a time interval within which the objects are to be received by a distribution center (or destination device) and/or provided to an end user that generated the object request (e.g., via pickup or delivery, etc.).

At block 1008, the computing device may identify an indication of object transmission capabilities. The object transmission capabilities may be determined by a quantity of available delivery devices and/or operators configured to transmit objects, characteristics of the delivery devices (e.g., type such as, a two-wheeled vehicle, four-wheeled vehicle, unmanned vehicle such as a manually or automatically operated drone, car, van, truck, refrigerated truck, scooter, bicycle, etc.; size; maximum travel time and/or distances; load capacity; fuel type such as gasoline or electric; mileage; historical routes traveled; and/or the like) and/or operators, time intervals over which the delivery devices and/or operators are available to transmit objects, types and/or characteristics of objects that delivery device and/or operators are configured to deliver, combinations thereof, or the like.

At block 1012, the computing devices selects one or more independent environments from which objects may be obtained to satisfy the object request. In some instances, the one or more independent environments may be selected based on the object request and the transmission capabilities. The computing device may use other factors in addition or in place of the transmission capabilities such as, but not limited to, a value of the objects, a location of the independent environment relative to the distribution center or destination location, a location of other independent environments relative to other independent environments that may be providing objects for the object request, a route used to retrieve the objects and/or transmit the objects, weather, time of day, time of year, anticipated traffic, a score associated with the independent environments, combinations thereof, or the like.

The computing device may assign weights to the factors based on a relative importance of each factor. For example, the weights may be assigned based on a predetermined and/or received priority such as object value, object request completion speed, etc., based on current (real time) characteristics of the computing device and/or hyperlocal network, based on a quantity of time available to satisfy the object request (e.g., where value may be weighted higher when more time is available, and lower when less time is available, etc.).

At block 1016, the computing device may derive transmission characteristics of each object to be transmitted to satisfy the object request that include, but are not limited, object size, object mass, object dimensions, object appearance characteristics (e.g., color, images, graphics, etc.), and/or the like.

At block 1020, the computing device identifications a location of each independent environment selected to provide the objects of the object request (at block 1012).

At block 1024, the computing device receives a current and/or anticipated distribution center object capacity. The distribution center may store objects received from independent environments and/or other sources that are to be consolidated with objects provided by the distribution center and provided to end users (e.g., via pick up or last-channel delivery services) in a predetermined location of the distribution center. If the current capacity is less than a threshold capacity (e.g., such as equal to the objects being transmitted via this object request), the computing device may select an alternate destination location for the object such as another distribution center, a self-managed environment of the computing device, an independent environment, another location, and/or the like. The computing device may determine a destination location based on the capacity of the distribution center.

At block 1028, the computing device may derive a transmission time associated with each selected independent environment and the destination location. The transmission time may correspond to a predicted time interval within which the objects stored and/or provided by a selected independent environment will be retrieved for transmission. For the destination location, the transmission time may correspond to a predicted time interval within which the objects will be received by the destination location.

At block 1032, the computing defines one or more dynamic routes to be used to retrieve objects from the selected independent environments and transmit the objects to the destination location. The computing device may determine a quantity of dynamic routes to define based on one or more factors such as, but not limited to, a quantity of independent environments from which objects are being retrieved, a location of the independent environments relative to each other and relative to the destination location, traffic, weather, time of day, time of year, the transmission capabilities determined at block 1008, user input, and/or the like. In some instances, the computing device may minimize the quantity of dynamic routes. In other instances, the computing device may define additional dynamic routes to reduce a time interval needed to satisfy the object request (e.g., such as when the independent environments are far apart, etc.). The computing device may use any of the previously described methods and/or systems to generate dynamic routes.

At block 1036, the computing device transmits a specification to one or more delivery devices and/or computing devices operated by operators of the one or more delivery devices. The specification may include the dynamic route for the delivery device, an identification of the objects to be retrieved at each independent environment of the dynamic route, characteristics of the objects (e.g., size, shape, mass, etc.), and/or the like. The computing device may generate a specification for each dynamic route defined to satisfy the object request. Each specification may be transmitted to a different delivery device and/or computing device.

Upon execution of each specification, the delivery device may transmit the objects identified by the respective specification to the destination location. In some instances, the object may be consolidated with other objects such as those received from other delivery device and/or those provided by the destination location. An object package may be formed from the consolidated objects and prepared for distribution to the end user (e.g., via pickup at the destination location, delivery via a last-channel delivery service, and/or the like).

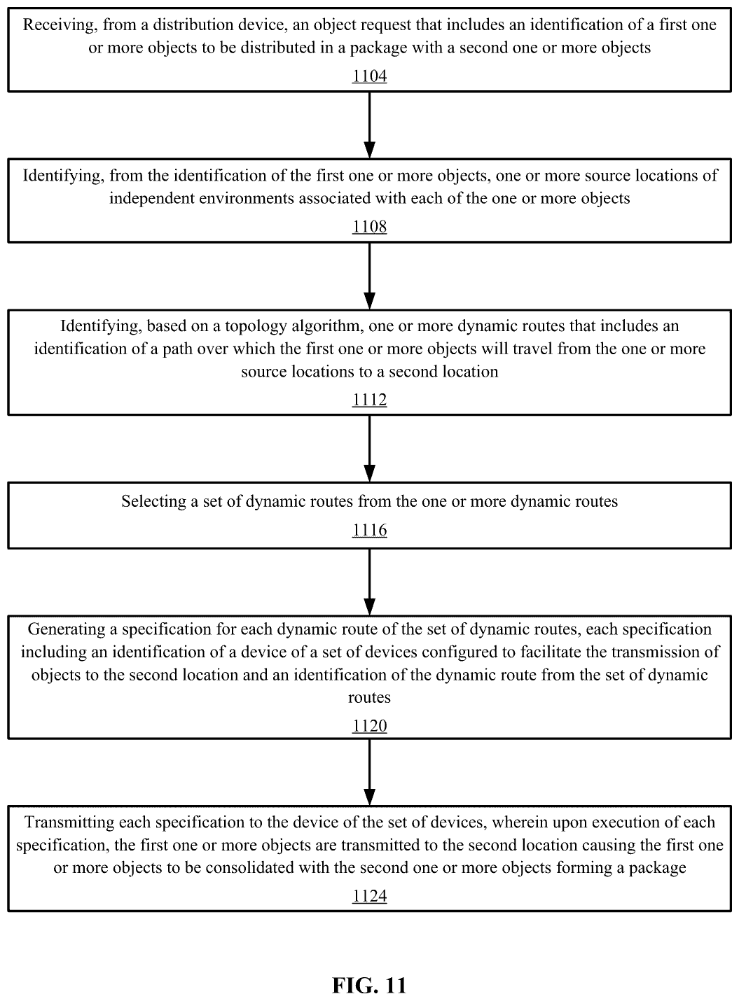

FIG. 11 illustrates a flowchart of another example process of consolidating objects of one or more independent environments with primary objects of a distribution center according to aspects of the present disclosure.

At block 1104, a computing device receives an object request from a distribution device. The distribution device may be a device operated by a distribution environment and/or a distribution center. The object request may include an identification of a first one or more objects to be provided by one or more independent environments and a second one or more objects to be provided by the distribution environment. In some instances, the object request may include an identification of only the first one or more objects that are to be obtained from the one or more independent environments. The object request may also include a time interval within which the one or more objects are to be received at a distribution center (or destination location) or provided to the end user.

At block 1108, the computing device identifies one or more source locations of independent environments associated with the first one or more objects. The computing device may use a hyperlocal network to determine possible independent environments from which the objects may be obtained to satisfy the object request. For example, the possible independent environments may include independent environment allocate to the distribution center or destination location. The computing device may then use manifest data received from the possible independent environments as well as one or more other factors to select one or more independent environments from which the first one or more objects are to be obtained (e.g., using any of the previously described means). The computing device then determines the source location (e.g., physical location, location with the hyperlocal network or logistical map, etc.) of the selected independent environments.

At block 1112, the computing device may generate one or more dynamic routes using a topology algorithm. A dynamic route may include a starting location, a path to one or more independent environments from which the first one or more objects are to be retrieved for transmission, and a second location that corresponds to a distribution center, a distribution environment, a self-managed environment, an independent environment, or the like. The computing device may generate the one or more dynamic routes using one or more factors such as, but not limited to, a current location or anticipated location of delivery devices, availability of delivery devices, locations of independent environments, a location of the second location, time of day, time of year, weather, quantity of objects being transmitted, characteristics of the objects being transmitted, characteristics of delivery devices, etc. In some instances, the computing device may generate a directed graph from a hyperlocal network and/or logistical map that includes the selected independent environments and the second location. Weights may be assigned to each node and/or edge of the directed graph based on any of the previously described factors. The topology algorithm may then define a transmission route using the directed graph that reaches the selected independent environments and the second location within the time interval of the object request. Alternatively, if multiple delivery devices are being provided, then the topology algorithm may then define one or more transmission routes using the directed graph, with each dynamic route reaching one or more of the selected independent environments and the second location within the time interval of the object request. The computing device may also define one or more alternative dynamic routes by setting the weights of edges and/or nodes to create various what-if scenarios (e.g., road closures, traffic, etc.). In some examples, such a route may be defined using Dijkstra's algorithm or the like.

Alternatively, or additionally, one or more of the dynamic routes may be predefined. Devices configured to transmit objects to a distribution center (or other second location), may transmit a large quantity of objects throughout a particular time interval (e.g., such as a day, week, month, etc.). The computing device may generate dynamic routes for devices that may transmit objects from a same set of independent environments to a same second location multiple times within the particular time interval. When a new object request is received, the computing device may selected a predefined dynamic route, if the objects are stored by an independent environment along a predefined dynamic route and/or if a device is already planned to transmit objects along the predefined dynamic route for other object requests. Though the computing device may be selected the predefined dynamic route, the computing device may be really selecting the device that is already transmitting objects along the predefined dynamic route for use in transmitting one or more of the objects of this object request.

At block 1116, the computing device may select a set of dynamic routes from the one or more routes. The set of routes may be selected based on a real time status of the computing device and/or of the hyperlocal network, user input, and/or the like. In some examples, the set of routes may be selected to reduce a quantity of delivery devices needed to transmit the first one or more objects. In other instances, the set of routes may be selected based on the time interval within which the first one or more objects are to be received at the second location. For example, if the computing device receives the object request with greater than a threshold quantity of time, the computing device may select the set of dynamic routes by minimizing the quantity of routes or based on an ability to satisfy other object requests, etc. If the computing device receives the object request with less than the threshold quantity of time, then the computing device may select the dynamic routes based on an ability to satisfy the object request within the designated time interval. Other factors may be used in addition or in place those previously described (e.g., such as weather, time of day, anticipated traffic, or any of the factors or method previously described).

At block 1120, the computing device may generate a specification for each dynamic route of the set of dynamic routes. Each specification may include an identification of a delivery device and/or computing device of an operator of a delivery device (e.g., a device of a set of devices) to which the specification is to be transmitted, an identification of the dynamic route, an identification of the objects to be retrieved along the dynamic route, an identification of the independent environments from which the objects are to be retrieved, an identification of the second location, characteristics of the objects being retrieved, one or more alternative dynamic routes (if needed), a time interval within which objects are to be retrieved from each independent environment along the dynamic route, a time interval within which the objects are to be transmitted to the second location, and/or the like.

At block 1124, the computing device may transmit the specifications to the designated devices of the set of devices. In some instances, the specifications may be executed immediately, causing the corresponding delivery device to facilitate the transmission of the first one or more objects to the second location. In other instances, the specifications may be executed at a designated time. When the first one or more objects reach the second location, the first one or more objects may be consolidated with the second one or more objects to form a package.

The computing device may transmit one or more status communications during the transmission of objects. For example, the computing device may transmit a communication confirm receipt of the object request to the distribution device and/or the end user. Another communication may be transmitted to independent environments with the portion of object request that may be satisfied by objects from the independent environment and a time interval indicating when the objects are to be prepared for transmission. Another communication may be transmitted to the distribution device, second location, and/or end user when the objects are received at the second location. Other communications may be transmitted in addition to or in place of those communications. Additionally, or alternatively, the computing device may generate a real time status of the object request in a network accessible location (e.g., associated with a URL or other address) or a location accessible via an API. The end user (e.g., via an application or through a website of the distribution device), distribution device, independent environments, and/or the like may access the real time status of the object request using the network accessible location, APIs, etc.

Upon completion of the object request, the computing device may update internal manifests that correspond to objects available by the independent environments. The computing device may request confirmation of the availability of objects from the independent environments. The independent environments may indicate a confirmation, provide an updated manifest, and/or a delta data structure usable to update the manifests of the computing device. The computing device may then synchronize the manifests of the computing devices with the distribution device (and/or other distribution devices). In some instances, the computing device may transmit the updated manifests or delta data structure to the distribution device. In other instances, the computing device may store the updated manifests and/or delta data structure in a network accessible location or other location accessible via APIs.

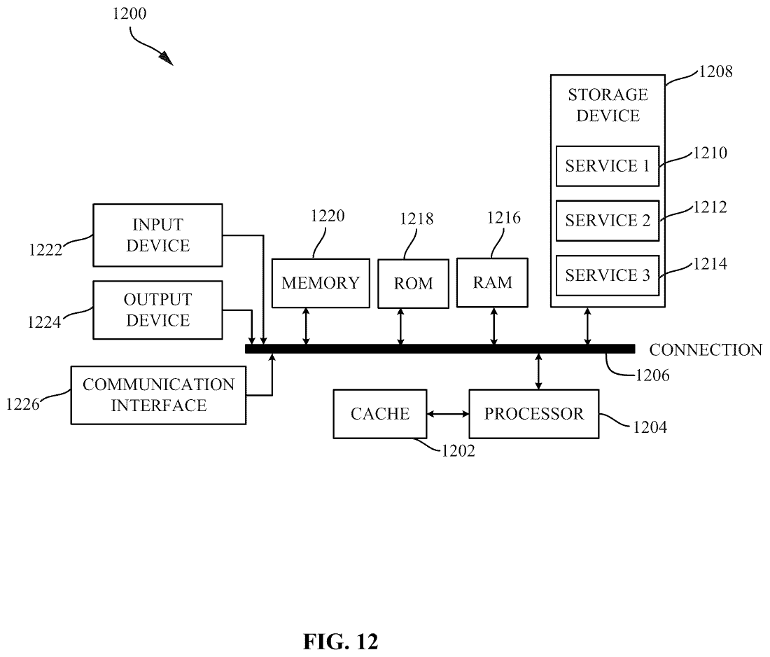

FIG. 12 illustrates an example computing system architecture including various components in electrical communication with each other and configured to implement aspects of the present disclosure. FIG. 12 illustrates a computing system architecture 1200 including various components in electrical communication with each other using a connection 1206, such as a bus, in accordance with some implementations. Example system architecture 1200 includes a processing unit (CPU or processor) 1204 and a system connection 1206 that couples various system components including the system memory 1220, such as ROM 1218 and RAM 1216, to the processor 1204. The system architecture 1200 can include a cache 1202 of high-speed memory connected directly with, in close proximity to, or integrated as part of the processor 1204. The system architecture 1200 can copy data from the memory 1220 and/or the storage device 1208 to the cache 1202 for quick access by the processor 1204. In this way, the cache can provide a performance boost that avoids processor 1204 delays while waiting for data. These and other modules can control or be configured to control the processor 1204 to perform various actions.

Other system memory 1220 may be available for use as well. The memory 1220 can include multiple different types of memory with different performance characteristics. The processor 1204 can include any general-purpose processor and a hardware or software service, such as service 1 1210, service 2 1212, and service 3 1214 stored in storage device 1208, configured to control the processor 1204 as well as a special-purpose processor where software instructions are incorporated into the actual processor design. The processor 1204 may be a completely self-contained computing system, containing multiple cores or processors, a bus, memory controller, cache, etc. A multi-core processor may be symmetric or asymmetric.

To enable user interaction with the computing system architecture 1200, an input device 1222 can represent any number of input mechanisms, such as a microphone for speech, a touch-sensitive screen for gesture or graphical input, keyboard, mouse, motion input, speech and so forth. An output device 1224 can also be one or more of a number of output mechanisms known to those of skill in the art. In some instances, multimodal systems can enable a user to provide multiple types of input to communicate with the computing system architecture 1200. The communications interface 1226 can generally govern and manage the user input and system output. There is no restriction on operating on any particular hardware arrangement and therefore the basic features here may easily be substituted for improved hardware or firmware arrangements as they are developed.

Storage device 1208 is a non-volatile memory and can be a hard disk or other types of computer readable media which can store data that are accessible by a computer, such as magnetic cassettes, flash memory cards, solid state memory devices, digital versatile disks, cartridges, RAMs 1216, ROM 1218, and hybrids thereof.

The storage device 1208 can include services 1210, 1212, 1214 for controlling the processor 1204. Other hardware or software modules are contemplated. The storage device 1208 can be connected to the system connection 1206. In one aspect, a hardware module that performs a particular function can include the software component stored in a computer-readable medium in connection with the necessary hardware components, such as the processor 1204, connection 1206, output device 1224, and so forth, to carry out the function.

The following examples are example implementations of various aspects of the disclosure. Any reference to a series of examples is to be understood as a reference to each of those examples disjunctively (e.g., “Examples 1-4” is to be understood as “Examples 1, 2, 3, or 4”).

Example 1 is a computer-implemented method comprising: receiving, from a distribution device, an object request that includes an identification of a first one or more objects to be distributed in a package with a second one or more objects; identifying, from the identification of the first one or more objects, one or more source locations of independent environments associated with each of the one or more objects; identifying, based on a topology algorithm, one or more dynamic routes that includes an identification of a path over which the first one or more objects will travel from the one or more source locations to a second location; selecting a set of dynamic routes from the one or more dynamic routes; generating a specification for each dynamic route of the set of dynamic routes, each specification including an identification of a device of a set of devices configured to facilitate the transmission of objects to the second location and an identification of the dynamic route from the set of dynamic routes; and transmitting each specification to the device of the set of devices, wherein upon execution of each specification, the first one or more objects are transmitted to the second location causing the first one or more objects to be consolidated with the second one or more objects forming a package.

Example 2 is the computer-implemented method of any of example(s) 1 and 3-20, wherein the object request further includes a time interval within which the package is to be transmitted to or received by an end user.

Example 3 is the computer-implemented method of any of example(s) 1-2 and 4-20, wherein the set of dynamic routes are selected based on a time interval within which the first one or more objects are to be received at the second location.

Example 4 is the computer-implemented method of any of example(s) 1-3 and 5-20, wherein the specification is generated by a machine-learning model trained from a set of historical object requests.

Example 5 is the computer-implemented method of any of example(s) 1-4 and 6-20, further comprising: transmitting a communication to a device associated with the source location of at least one object of the first one or more object, the communication including an identifier associated with the object request and a time interval within which the at least one object is to be prepared for transmission to the location associated with the distribution device.

Example 6 is the computer-implemented method of any of example(s) 1-5 and 7-20, further comprising: transmitting a communication to the distribution device indicating that at least one object of the first one or more objects has been transmitted to the second location.

Example 7 is the computer-implemented method of any of example(s) 1-6 and 8-20, further comprising: receiving, from a device associated with a particular source location, an object manifest corresponding to a third one or more objects, the object manifest including object characteristics corresponding to the third one or more objects, wherein the object characteristics include one or more of a quantity of each object of the third one or more objects stored by the particular source location or a value of each object of the third one or more objects; and transmitting, to the distribution device, the object manifest, wherein upon receiving the object manifest, the distribution is configured to transmit subsequent object requests that include to objects identified by the object manifest.

Example 8 is the computer-implemented method of any of example(s) 1-7 and 9-20, further comprising: receiving, from the device associated with the particular source location and in response to execution of at least one specification associated with the particular source location, an updated object manifest, the updated object manifest including modified object characteristics corresponding to the third one or more objects stored by the particular source location; and transmitting, to the distribution device, the updated object manifest.

Example 9 is the computer-implemented method of any of example(s) 1-8 and 10-20, wherein the modified object characteristics include one or more of a new quantity of an object of the third one or more objects, a new value of an object of the third one or more objects, or a special value of an object of the third one or more objects.

Example 10 is the computer-implemented method of any of example(s) 1-9 and 11-20, further comprising: receiving an identification of one or more source locations configured to provide objects through devices associated with one or more distribution locations; and allocating each source location of the one or more source locations to a distribution location based on the topology algorithm, object value of one or more objects of each source location, or user input, wherein object requests received from devices associated with a particular distribution location are satisfied by source locations allocated to the particular distribution location.

Example 11 is the computer-implemented method of any of example(s) 1-10 and 12-20, wherein identifying one or more dynamic routes comprises: identifying, for each object of the first one or more objects, one or more source locations allocated to a distribution location associated with the distribution device.

Example 12 is the computer-implemented method of any of example(s) 1-11 and 13-20, wherein identifying one or more dynamic routes comprises: determining that at least one object of the first one or more objects is not stored by a source location allocated to the distribution location associated with the distribution device; and identifying a particular source location allocated to a different distribution location that is storing the at least one object.

Example 13 is the computer-implemented method of any of example(s) 1-12 and 14-20, wherein the second location is a location associated with the distribution device, and wherein the first one or more objects and the second one or more objects are consolidated at the second location.

Example 14 is the computer-implemented method of any of example(s) 1-13 and 15-20, wherein the package is configured for transmission to an end user by another device in communication with the distribution device.

Example 15 is the computer-implemented method of any of example(s) 1-14 and 16-20, wherein the package is configured to be received by an end user at the second location.

Example 16 is the computer-implemented method of any of example(s) 1-15 and 17-20, wherein the second location is the source location.

Example 17 is the computer-implemented method of any of example(s) 1-16 and 18-20, wherein the first one or more objects and the second one or more objects are consolidated at the second location.

Example 18 is the computer-implemented method of any of example(s) 1-17 and 19-20, wherein the package is configured for transmission to an end user by a device associated with the second location.

Example 19 is the computer-implemented method of any of example(s) 1-18 and 20, wherein the package is configured to be received at the second location.

Example 20 is the computer-implemented method of any of example(s) 1-19, wherein the first one or more objects are transmitted to the location associated with the distribution device via one or more of: a manned vehicle or an unmanned vehicle.

Example 21 is a system comprising: one or more processors; and a non-transitory machine-readable storage medium storing instructions that when executed by the one or more processors, cause the one or more processors to perform any of example(s)s 1-20.

Example 22 is a non-transitory machine-readable storage medium storing instructions that when executed by one or more processors, cause the one or more processors to perform any of example(s)s 1-20.

The disclosed middle-channel consolidation system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory.

This disclosure contemplates the computer system taking any suitable physical form, including, but not limited to, a computing device, mobile device, server, network (e.g., such as a local area network, cloud network, or the like), distributed system (e.g., operating over one or more computer systems, etc.), combinations thereof, or the like. As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor, microntroller, application-specific integrated circuit, field-programmable gate array, and/or the like. One of skill in the relevant art will recognize that the terms “machine-readable (storage) medium” or “computer-readable (storage) medium” include any type of device that is accessible by the processor. The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it may be moved to a computer readable location appropriate for processing (random-access memory, flash memory, cache memory, etc.), and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDNO modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the terms “computer readable medium”, “computer readable storage medium”, “machine-readable medium” and “machine-readable storage medium” should be taken to include a single medium or multiple media (e.g., a centralized or distributed database, and/or associated caches and servers) that store the one or more sets of instructions. The terms “computer readable medium”, “computer readable storage medium”, “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included (e.g., in FIGS. 6-11). A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a keypad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving, from a distribution device, an object request that includes an identification of a first one or more objects to be distributed in a package with a second one or more objects;
identifying, from the identification of the first one or more objects, one or more source locations of independent environments associated with each of the one or more objects;
identifying, based on a topology algorithm, one or more dynamic routes that includes an identification of a path over which the first one or more objects will travel from the one or more source locations to a second location;
selecting a set of dynamic routes from the one or more dynamic routes;
generating a specification for each dynamic route of the set of dynamic routes, each specification including an identification of a device of a set of devices configured to facilitate the transmission of objects to the second location and an identification of the dynamic route from the set of dynamic routes; and
transmitting each specification to the device of the set of devices, wherein upon execution of each specification, the first one or more objects are transmitted to the second location causing the first one or more objects to be consolidated with the second one or more objects forming a package.

2. The computer-implemented method of claim 1, wherein the object request further includes a time interval within which the package is to be transmitted to or received by an end user.

3. The computer-implemented method of claim 1, wherein the set of dynamic routes are selected based on a time interval within which the first one or more objects are to be received at the second location.

4. The computer-implemented method of claim 1, wherein the specification is generated by a machine-learning model trained from a set of historical object requests.

5. The computer-implemented method of claim 1, further comprising:
transmitting a communication to a device associated with the source location of at least one object of the first one or more object, the communication including an identifier associated with the object request and a time interval within which the at least one object is to be prepared for transmission to the location associated with the distribution device.

6. The computer-implemented method of claim 1, further comprising:
transmitting a communication to the distribution device indicating that at least one object of the first one or more object has been transmitted to the second location.

7. The computer-implemented method of claim 1, further comprising:
receiving, from a device associated with a particular source location, an object manifest corresponding to a third one or more objects, the object manifest including object characteristics corresponding to the third one or more objects, wherein the object characteristics include one or more of a quantity of each object of the third one or more objects stored by the particular source location or a value of each object of the third one or more objects; and
transmitting, to the distribution device, the object manifest, wherein upon receiving the object manifest, the distribution is configured to transmit subsequent object requests that include to objects identified by the object manifest.

8. A system comprising:
one or more processors; and
a non-transitory machine-readable storage medium storing instructions that when executed by the one or more processors, cause the one or more processors to perform operations including:
receiving, from a distribution device, an object request that includes an identification of a first one or more objects to be distributed in a package with a second one or more objects;
identifying, from the identification of the first one or more objects, one or more source locations of independent environments associated with each of the one or more objects;
identifying, based on a topology algorithm, one or more dynamic routes that includes an identification of a path over which the first one or more objects will travel from the one or more source locations to a second location;
selecting a set of dynamic routes from the one or more dynamic routes;
generating a specification for each dynamic route of the set of dynamic routes, each specification including an identification of a device of a set of devices configured to facilitate the transmission of objects to the second location and an identification of the dynamic route from the set of dynamic routes; and
transmitting each specification to the device of the set of devices, wherein upon execution of each specification, the first one or more objects are transmitted to the second location causing the first one or more objects to be consolidated with the second one or more objects forming a package.

9. The system of claim 8, wherein the object request further includes a time interval within which the package is to be transmitted to or received by an end user.

10. The system of claim 8, wherein the set of dynamic routes are selected based on a time interval within which the first one or more objects are to be received at the second location.

11. The system of claim 8, wherein the specification is generated by a machine-learning model trained from a set of historical object requests.

12. The system of claim 8, wherein the operations further include:
transmitting a communication to a device associated with the source location of at least one object of the first one or more object, the communication including an identifier associated with the object request and a time interval within which the at least one object is to be prepared for transmission to the location associated with the distribution device.

13. The system of claim 8, wherein the operations further include:
transmitting a communication to the distribution device indicating that at least one object of the first one or more object has been transmitted to the second location.

14. The system of claim 8, wherein the operations further include:
receiving, from a device associated with a particular source location, an object manifest corresponding to a third one or more objects, the object manifest including object characteristics corresponding to the third one or more objects, wherein the object characteristics include one or more of a quantity of each object of the third one or more objects stored by the particular source location or a value of each object of the third one or more objects; and
transmitting, to the distribution device, the object manifest, wherein upon receiving the object manifest, the distribution is configured to transmit subsequent object requests that include to objects identified by the object manifest.

15. A non-transitory machine-readable storage medium storing instructions that when executed by one or more processors, cause the one or more processors to perform operations including:
receiving, from a distribution device, an object request that includes an identification of a first one or more objects to be distributed in a package with a second one or more objects;
identifying, from the identification of the first one or more objects, one or more source locations of independent environments associated with each of the one or more objects;
identifying, based on a topology algorithm, one or more dynamic routes that includes an identification of a path over which the first one or more objects will travel from the one or more source locations to a second location;
selecting a set of dynamic routes from the one or more dynamic routes;
generating a specification for each dynamic route of the set of dynamic routes, each specification including an identification of a device of a set of devices configured to facilitate the transmission of objects to the second location and an identification of the dynamic route from the set of dynamic routes; and
transmitting each specification to the device of the set of devices, wherein upon execution of each specification, the first one or more objects are transmitted to the second location causing the first one or more objects to be consolidated with the second one or more objects forming a package.

16. The non-transitory machine-readable storage medium of claim 15, wherein the object request further includes a time interval within which the package is to be transmitted to or received by an end user.

17. The non-transitory machine-readable storage medium of claim 15, wherein the set of dynamic routes are selected based on a time interval within which the first one or more objects are to be received at the second location.

18. The non-transitory machine-readable storage medium of claim 15, wherein the specification is generated by a machine-learning model trained from a set of historical object requests.

19. The non-transitory machine-readable storage medium of claim 15, wherein the operations further include:
transmitting a communication to a device associated with the source location of at least one object of the first one or more object, the communication including an identifier associated with the object request and a time interval within which the at least one object is to be prepared for transmission to the location associated with the distribution device.

20. The non-transitory machine-readable storage medium of claim 15, wherein the operations further include:
receiving, from a device associated with a particular source location, an object manifest corresponding to a third one or more objects, the object manifest including object characteristics corresponding to the third one or more objects, wherein the object characteristics include one or more of a quantity of each object of the third one or more objects stored by the particular source location or a value of each object of the third one or more objects; and
transmitting, to the distribution device, the object manifest, wherein upon receiving the object manifest, the distribution is configured to transmit subsequent object requests that include to objects identified by the object manifest.
